(19) United States
(12) Patent Application Publication
(10) Pub. No.: US 2012/0067249 A1
(43) Pub. Date: Mar. 22, 2012

(54) MOISTURE CURABLE POLYDISULFIDES

(75) Inventors: John G. Woods, Farmington, CT (US); Anthony F. Jacobine, Meriden, CT (US); Johann Klein, Duesseldorf (DE); Kathrin Isenbuegel, Erkrath (DE)

(73) Assignees: Henkel AG & Co. KGaA, Duesseldorf (DE); Henkel Corporation, Rocky Hill, CT (US)

(21) Appl. No.: 13/285,187

(22) Filed: Oct. 31, 2011

Related U.S. Application Data
(63) Continuation of application No. PCT/US2010/032641, filed on Apr. 28, 2010.
(60) Provisional application No. 61/173,877, filed on Apr. 29, 2009.

(51) Int. Cl. C09J 9/00; C07F 7/18

(52) U.S. Cl. 106/287.25; 556/428; 556/420; 106/287.23

(57) ABSTRACT

Provided are polydisulfides that are useful in moisture curable sealants. The polydisulfides have an S—S link in the backbone and are end-capped with at least one alkoxysilane functional group. Also provided are methods of making the polydisulfides, including methods that do not require the presence of a catalyst.

### BACKGROUND OF THE INVENTION

1. Field of the Invention

The present invention relates to polydisulfides useful in moisture curable adhesive compositions which can cure through alkoxysilane groups to form high strength bonded articles.

2. Description of Related Art

Alkoxysilylated polymers can be crosslinked by atmospheric moisture under ambient conditions. Compositions based on these types of polymers are often referred to as RTV sealants (or adhesives). The most well known example is RTV silicone sealants.

Flexible RTV moisture curing polymers have been known in the art as useful adhesives, coatings, potting compounds, and sealants. Silicones, urethanes, silicone/urethanes, silicone/acrylates to name a few general classes have been widely used.

For example, U.S. Pat. No. 5,554,709 discloses moisture-curing, alkoxysilane-functional polyurethanes and to their use in adhesives and sealing compositions. U.S. Pat. No. 7,009,022 discloses moisture curable siloxy end-capped ABA triblock copolymers which have a backbone having polyether and polyester segments joined by urethane and/or urea linkages.

Polysulfides represent another important class of materials for use in sealant products where low temperature performance, chemical resistance, and mechanical stress relaxation are required, for example, in aircraft fuel tank sealing, insulated glazing and building construction. In addition, polysulfides may be used as reactive additives for the toughening of structural adhesives such as epoxies, as described in U.S. Pat. No. 7,087,304.

The most common method of curing polysulfides is by the addition of oxidizing agents such as manganese dioxide or cumene hydroperoxide. However, since the pot-lives of these compositions are relatively short, they are typically available as two-component systems. Moreover, these oxidizing agents are reactive and frequently toxic.

### SUMMARY

In one aspect of the invention, there is provided a reaction product prepared from reactants, in the presence of a free radical initiator, including: a) at least one thiol-functional polydisulfide; and b) at least one alkoxy silane, wherein the alkoxy silane has at least one alkenyl-functional group.

In another aspect of the invention, there is provided a reaction product prepared from reactants including: a) at least one thiol-functional polydisulfide; and b) at least one alkoxy silane, wherein the alkoxy silane has at least one isocyanato-functional group.

In another aspect of the invention, there is provided a reaction product prepared from reactants including: (a) at least one isocyanato functional polydisulfide; and (b) at least one alkoxy silane having at least one amino functional group.

In another aspect of the invention, there is provided a reaction product prepared from reactants including: (a) at least one acryl-functional polydisulfide; and (b) at least one alkoxy silane having at least one thiol functional group.

In another aspect of the invention, there is provided a moisture curable sealant which includes one or more of the above reaction products in combination with a catalyst.

In another aspect of the invention, there is provided a process of preparing the above polydisulfide materials having at least one alkoxy silane functional group.

In some embodiments, the process includes the step of reacting reactants including at least one thiol-functional polydisulfide and at least one alkoxy silane having at least one alkenyl-functional group in the presence of a free radical initiator.

In some embodiments, the process includes the step of reacting reactants including at least one thiol-functional polydisulfide and at least one alkoxy silane having at least one isocyanato-functional group.

In some embodiments, the process includes the step of reacting reactants including at least one isocyanato-functional polydisulfide and at least one alkoxy silane having at least one amino-functional group.

In some embodiments, the process includes the step of reacting reactants including at least one acryl-functional polydisulfide and at least one alkoxy silane having at least one thiol-functional group. The acryl-functional polydisulfide may be prepared by reacting at least one material having at least two acryl-functional groups and at least one thiol-functional polydisulfide material.

### BRIEF DESCRIPTION OF THE DRAWINGS

FIG. 1 is a graphic depiction of the tensile strength and elongation at break of compositions according to the present invention compared with a commercially available product.

FIG. 2 is a graphical depiction showing the effects of a low molecular weight di-functional alkoxysilane on tensile strength and elongation at break.

FIGS. 3a-d is a graphical depiction showing the resistances of moisture-cured polydisulfide sealants according to the present invention to motor oil, n-heptane, anti-freeze, and hot water.

FIG. 4 is a graphical depiction showing the resistance of a moisture-cured polydisulfide sealant according to the present invention to motor oil compared with a commercially available product.

FIG. 5 is a graphical depiction of the tensile strength and elongation at break of compositions according to the present invention after exposure to motor oil.

FIG. 6 is a graphical depiction showing the resistances of moisture-cured polydisulfide sealants according to the present invention to motor oil compared to a commercially available product.

### DETAILED DESCRIPTION

Other than in the operating examples, or where otherwise indicated, all numbers expressing quantities of ingredients, thermal conditions, and so forth used in the specification and claims are to be understood as being modified in all instances by the term “about.” Accordingly, unless indicated to the contrary, the numerical parameters set forth in the following specification and attached claims are approximations that may vary depending on the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Also, it should be understood that any numerical range recited herein is intended to include all sub-ranges subsumed therein. For example, a range of “1 to 10” is intended to include all sub-ranges between and including the recited minimum value of 1 and the recited maximum value of 10, that is, having a minimum value equal to or greater than 1 and a maximum value of equal to or less than 10.

As used herein, the term “composition” is intended to encompass a product comprising the specified ingredients in the specified amounts, as well as any product which results, directly or indirectly, from combination of the specified ingredients in the specified amounts.

As used herein, “formed from” or “prepared from” denotes open, e.g., “comprising.” claim language. As such, it is intended that a composition “formed from” or “prepared from” a list of recited components be a composition comprising at least these recited components or the reaction product of at least these recited components, and can further comprise other, non-recited components, during the composition's formation or preparation.

Provided are alkoxysilane-functional polydisulfides as well as moisture curable sealant compositions comprising the same and methods of preparing the same.

Discussion of the various aspects and embodiments of alkoxysilane-functional polydisulfides of the present invention have been grouped generally in Groups A-D below. These groupings are not intended to limit the scope of the invention and aspects of one grouping may be relevant to the subject matter of other groupings. Also, limitations as to amounts of reactants in one grouping are not necessarily intended to limit amounts of the same component in other groupings, although appropriate amounts may be the same for a different grouping unless otherwise indicated.

### Group A

In some non-limiting embodiments, the alkoxysilane-functional polydisulfides of the present invention are provided as the reaction product of reactants including at least one thiol-functional polydisulfide and at least one alkenyl-functional alkoxy silane, where the reaction of the reactants is in the presence of a free radical initiator.

Non-limiting examples of thiol-functional polydisulfides for use in the present invention include liquid thiol-functional polydisulfides, for example, having one of the following general structures:

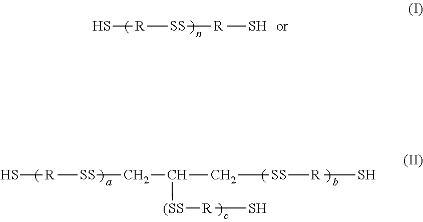

wherein each R can be independently alkylene or substituted alkylene, oxyalkylene or substituted oxyalkylene, or thiaalkylene or substituted thiaalkylene, a+b+c=n, and n can be at least about 2 up, to about 60, such as between about 4 and about 30.

“Alkylene” means a difunctional group obtained by removal of a hydrogen atom from an alkyl group. Non-limiting examples of alkylene include methylene, ethylene, and propylene.

“Oxyalkylene” refers to the moiety —O-alkylene-, wherein alkylene is as defined above.

“Thiaalkylene” refers to the moiety —S-alkylene-, wherein alkylene group is as defined above.

The term “substituted” means that one or more hydrogens on the designated atom is replaced, provided that the designated atom's normal valency under the existing circumstances is not exceeded, and that the substitution results in a stable compound. Combinations of substituents and/or variables are permissible only if such combinations result in stable compounds.

R, on average, can have a backbone greater than 6 atoms in length. Exemplary R's include such bivalent species as —(CH₂)₇—, —(CH₂)₁₀—, —(CH₂)₄—O—(CH₂)₄—, —(CH₂)₂—O—CH₂—O—(CH₂)₂—, —(CH₂)₄—O—CH₂—O—(CH₂)₄—, and the like. One particularly useful R is —(CH₂)₂—O—CH₂—O—(CH₂)₂—. Some commercially available polydisulfides of this type include those polydisulfides sold under the THIOKOL® mark, including LP-2, LP-3, LP-12, LP-23, LP-31, LP-32, LP-33, LP-55, LP-56, and LP-980, available from LP North America Distribution, Inc.

The thiol-functional polydisulfides typically have a thiol-equivalent weight of between about 500 and about 3000 g/equivalent and a number average molecular weight of between about 500 and about 40,000 g/mol.

Synthesis of thiol-terminated polydisulfides is well known in the art. For example, such materials can be obtained by the polycondensation of bis-(2-chloroethyl) formal with alkali polysulfide followed by degradation of the resulting polymer in the presence of base under conditions suitable to produce the thiol-terminated polydisulfides.

The thiol-functional polydisulfides described above can also undergo a chain extending reaction to produce an extended polydisulfide compound. Non-limiting examples of useful chain extending compounds include compounds having at least two isocyanato-functional groups, compounds having at least two acryl-functional groups, and compounds having a combination of isocyanato- and acryl-functional groups. A chain extending reaction can be used to build the molecular weight of the polydisulfide by reaction of the functional groups of the chain extender with the thiol-functional groups of the polydisulfide compound to link polydisulfide compounds in an end-to-end arrangement. A chain extender compound can also be used to build block copolymers containing polydisulfide units covalently linked with, for example, polyether, polyurethane, polyacrylate, polyester, polybutadiene, or polyamide blocks in an A-B-A arrangement where A represents the polydisulfide and B represents the polyether, polyacrylate, etc. This is significant since individual blends of polydisulfides with, for instance, polyethers, are generally incompatible. By covalently incorporating blocks of polyethers, polyacrylates, etc., it is possible to obtain a polydisulfide having polymer morphologies and properties not accessible by simple blending. For example, copolymers comprised of polydisulfide and poly(propylene oxide) or copolymers comprised of polydisulfides and polyethylene oxide) are possible.

For Group A compounds and Group B compounds (discussed below) it is desirable to maintain the thiol-functionality of the extended polydisulfide compounds for subsequent linkage with an alkoxysilane compound. This can be accomplished by controlling the relative amount of chain extender compound. Generally, to encourage the thiol-functionality of the extended polydisulfides, the ratio of the pre-extended thiol-functional polydisulfide to the chain extending compound is typically greater than 1:1, such as 2:1. By providing the thiol-functional polydisulfide in a molar excess, the chain extending compound can be completely or nearly completely consumed through the reaction, and a chain extended thiol-functional polydisulfide can be formed.

Non-limiting examples of isocyanato-functional compounds that can act as a chain extender may include, without limitation, any of the known aromatic, aliphatic, and cycloaliphatic di- or poly-functional isocyanates. Examples of suitable isocyanates include: 2,4- and 2,6-toluene diisocyanates and isomeric mixtures thereof; polyphenylene polymethylene polyisocyanates (poly-MDI, PMDI); the saturated, cycloaliphatic analogs of PMDI such as 2,4-, and 2,6-methylcyclohexane diisocyanate and 2,2′-, 2,4′-, and 4,4′-methylene dicyclohexylene diisocyanate and other isomers thereof; isophorone diisocyanate; 1,4-diisocyanatobutane; 1,5-diisocyanatopentane; 1,6-diisocyanatohexane; 1,4-cyclohexane diisocyanate; hexamethylene diisocyanate (HDI); meta-tetramethylxylene diisocyanate (m-TMXDI) and the like. Other useful isocyanates can be found in U.S. Pat. Nos. 4,309,526; 7,511,111; and 7,517,559, the contents of each of which are herein incorporated by reference.

It has been found that the chain extending reaction of a molar excess of a thiol-functional polydisulfide and a di- or poly-isocyanate can be carried out in the absence of a catalyst.

Other useful chain extended polydisulfides can be prepared by reacting a thiol-functional polydisulfide with an acryl-functional compound having two or more acryl-functional groups. Non-limiting examples of useful acryl-functional compounds include acryl-functional polyethers, acryl-functional polyacrylates, acryl-functional polybutadienes, acryl-functional polyamides, and acryl-functional polysiloxanes. In some particular examples, the acryl-functional compound can be a diacryl-functional compound such as ethylene glycol diacrylate, 1,3-butylene glycol diacrylate, 1,4-butanediol diacrylate, 1,6-hexanediol diacrylate, cyclohexane dimethanol diacrylate, alkoxylated hexanediol diacrylate, neopentyl glycol diacrylate, caprolactone modified neopentylglycol hydroxypivalate diacrylate, cyclohexanedimethanol diacrylate, diethylene glycol diacrylate, dipropylene glycol diacrylate, bisphenol-A diacrylate, ethoxylated bisphenol-A diacrylate, hydroxypivalaldehyde modified trimethylolpropane diacrylate, neopentyl glycol diacrylate, polyethylene glycol diacrylate, propoxylated neopentyl glycol diacrylate, tetraethylene glycol diacrylate, tricyclodecanedimethanol diacrylate, triethylene glycol diacrylate, and tripropylene glycol diacrylate. A list of other suitable diacrylates can be found in U.S. Pat. No. 7,473,719, the contents of which are incorporated herein by reference.

Reaction of a thiol-functional polydisulfide with an acryl-functional chain extender compound can be carried in the presence of a catalyst such as an amidine catalyst, an example of which is 1,8-Diazabicyclo[5.4.0]undec-7-ene (DBU), with the catalyst being provided in an amount of from about 0.1 to about 10.0 wt %, such as between 0.1 and 1.0 wt %, based on the total weight of the reactants. Again, if thiol-functionality of the extended polydisulfide is desired, the pre-extended thiol-functional polydisulfide should be provided in a molar excess compared with the chain extender acryl-functional compound.

As previously mentioned, the alkoxysilane-functional polydisulfides of Group A can be prepared by reacting a thiol-functional polydisulfide, such as those discussed above, with at least one alkenyl-functional alkoxy silane. As used herein, “alkenyl” refers to straight or branched chain hydrocarbyl groups having at least one unit of ethylenic unsaturation, i.e., a carbon-carbon double bond and having in the range of 2 up to about 12 carbon atoms. Non-limiting examples of useful alkenyl-functional alkoxy silanes include compounds of the following general structure:

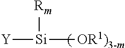

wherein m is 0-2; R is C₁₋₆ alkyl or C₆ aryl, which may optionally be substituted by halo, sulfur or oxygen; each R¹ is independently alkyl; and Y is an alkenyl group, such as a vinyl or allyl.

In some non-limiting examples, Y is a C₂-C₄ alkenyl group and each R¹ is independently a C₁-C₄ alkyl group. Non-limiting examples of suitable alkenyl-functional alkoxysilanes include vinyltrimethoxysilane, allyltrimethoxysilane, allyltriethoxysilane, hexenyltrimethoxysilane, undecylenyltrimethoxysilane, 3-methacryloyl oxypropyl trimethoxysilane, 3-methacryloyloxypropyl triethoxysilane, 3-acryloyloxypropyl trimethoxysilane, 3-acryloyloxypropyl triethoxysilane, and mixtures thereof.

The reaction of a thiol-functional polydisulfide and an alkenyl-functional alkoxysilane can be carried out in presence of a free radical initiator. This reaction can create a polydisulfide having alkoxysilane end groups through the thiol-ene addition of the alkoxysilane to the thiol-functional end groups of the polydisulfide. In this sense, the alkoxysilane groups can be said to “cap” the thiol-functional polydisulfide. This process is highly attractive because neither a product purification nor reaction solvents are necessary.

The thiol-ene addition is a typical radical-chain reaction initiated by peroxides or azonitrile compounds or by UV-light. In this process, a thiyl-radical is formed by abstraction of a hydrogen atom from the thiol SH group. This radical then adds to the alkene group of the unsaturated component in a reversible step, forming a carbon-centered radical. The carbon radical in turn abstracts hydrogen from thiol to form the saturated addition product and a new thiyl-radical, which propogates the chain. Unlike other radical addition reactions, the Anti-Markownikoff product is formed, when asymmetric olefins are employed. The thiyl radical addition occurs preferentially at the less-substituted end of the unsaturated system, while the more stable alkyl-radical is formed.

The alkoxysilane and polydisulfide can be provided in amounts such that there is at an equivalent amount of alkenyl-functional groups to thiol-functional groups. For instance, if the polydisulfide has two functional thiol groups (di-functional) and the alkoxysilane has one functional alkenyl group, then the molar ratio of alkoxysilane to polydisulfide should be at least 2:1. The use of a molar excess of alkenyl-functional alkoxysilane may be beneficial to drive the reaction to completeness and the excess amount can usually be removed by vacuum distillation at the end of the reaction.

Suitable free radical initiators include azo-compounds such as azobis(isobutyronitrile) (AIBN), azobis(4-methoxy-2,4-dimethylvaleronitrile (commercially available as “V-70”), and peroxides such as dicumyl peroxide, dibenzoyl peroxide and t-butyl peroxide. Initiator levels can range between 0.05 and 10.0% by weight, such as between 0.1 and 5.0% by weight, based on the total weight of the reactants. The free radical addition reaction can be carried out under temperature conditions between, for example, 35 and 120° C., such as between 50 and 90° C.

### Group B

In other non-limiting embodiments, alkoxysilane-functional polydisulfides of the present invention are provided as the reaction product of at least one thiol-functional polydisulfide and at least one isocyanato-functional alkoxysilane.

In this embodiment, non-limiting examples of useful thiol-functional polydisulfides include those thiol-functional polydisulfides discussed above, including the extended/block thiol-functional polydisulfides.

Non-limiting examples of isocyanato-functional alkoxysilanes useful in this invention generally conform to the structure:

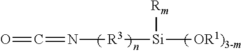

where n is 1-3; m is 0-2; R is C₁₋₆ alkyl or C₆ aryl, which may optionally be substituted by halo, sulfur or oxygen; each R¹ is independently C₁₋₆ alkyl; and each R³ is an alkylene, such as a C1-C6 alkylene.

Other non-limiting examples of useful isocyanato-functional alkoxysilanes include alkoxysilanes prepared from the reaction product of a diisocyanate and a molar equivalent amount of an amino- or thiol-functional alkoxy silane.

Particular examples of useful isocyanato-functional alkoxysilanes include γ-isocyanatopropyltrimethoxysilane γ-isocyanatopropyltriethoxysilane, (γ-isocyanatopropyl)methyldimethoxysilane, and (γ-isocyanatopropyl)methyldiethoxysilane.

The isocyanato group of the alkoxysilanes discussed above can react with the thiol-functional groups of the polydisulfide, and in this sense the isocyanato-functional alkoxysilanes can be said to “cap” the polydisulfide to produce an alkoxysilane-functional polydisulfide compound. The reaction of a thiol-functional polydisulfide and an isocyanato-functional alkoxysilane can be carried out with exclusion of humidity, to avoid foaming through by carbon dioxide, and with tightly controlled stoichiometric conditions. The process can be carried out with catalysts such as tindibutyl diacetate, dibutyltin dilaurate, triethylamine, zinc octoate, triethylenetetraamine, or other available catalysts used to promote a urethane and thiourethane reactions. Alternatively, it has been surprisingly discovered that the isocyanato-capping of the polydisulfide can be carried out under solvent- and/or catalyst-free conditions. Catalyst-free conditions may be preferred since the catalysts generally used to promote urethane and thiourethane reactions are also active in promoting moisture curing through alkoxysilanes. If such catalysts are present in an alkoxysilane-functional polydisulfide composition, it may result in a composition having poor storage stability.

To allow for complete or nearly complete capping of the thiol-functional polydisulfide with the isocyanato-functional alkoxysilane, there should be at least an equivalent amount of isocyanato-functional groups to thiol-functional groups. For example, when the thiol-functional polydisulfide has two functional thiol groups (di-functional) and the alkoxysilane has one functional isocyanato-functional group, then the molar ratio of alkoxysilane to polydisulfide should be at least 2:1. Non-limiting examples of suitable temperatures for the capping reaction include temperature ranging from ambient temperature to 90° C.

### Group C

In other non-limiting embodiments, the alkoxysilane-functional polydisulfides of the present invention are provided as the reaction product of reactants including at least one isocyanato-functional polydisulfide and at least one alkoxy silane having at least one amino-functional group.

Isocyanato-functional polydisulfides for use in this invention can be prepared from thiol-functional polydisulfides, such as those discussed above in Group A through thiol-isocyanate addition. The isocyanato-functional polydisulfides f Group C can also be an extended polydisulfide of Structures I or II, wherein the chain extension has been carried out utilizing the isocyanate chain extending compounds discussed in connection with Group A. Contrary to the compounds discussed in Groups A and B, however, the initial or pre-extended thiol-functional polydisulfides should be converted to an isocyanato-functional arrangement where each polydisulfide has at least one isocyanato-functional endgroup. Generally, to encourage the isocyanato-functionality of the polydisulfides, the stoichiometric ratio of the di- or poly-functional isocyanate to the thiol-functional polydisulfide is typically greater than 1:1, such as 2:1. By providing the di- or poly-functional isocyanate in a molar excess, the thiol-functional polydisulfide can be completely or nearly completely consumed through the reaction, and a high amount of isocyanato-functional, or “capped,” polydisulfide can be formed.

Isocyanato-functional compounds useful in reacting with a thiol-functional polydisulfide to form an isocyanato-functional polydisulfide may include any of the di- or poly-functional isocyanates discussed in Group A. Isocyanato-capping of a thiol-functional polydisulfide can be carried out with catalysts such as tindibutyl diacetate, tindibutyl dilaurate, triethylamine, zinc octoate, triethylenetetraamine or other available catalysts used to promote a urethane and thiourethane reactions. As discussed above, the isocyanato-capping of the polydisulfide can be carried out under solvent- and/or catalyst-free conditions, which may be preferred.

Any primary or secondary amino-functional alkoxysilanes can be used as the second component of the reaction product. Non-limiting examples of suitable amino-functional alkoxy silanes include those amino-functional alkoxy silanes represented by the formula:

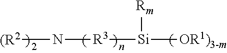

where n is 1-3; m is 0-2; R is C₁₋₆ alkyl or C₆ aryl, which may optionally be substituted by halo, sulfur or oxygen; each R¹ is independently C₁₋₆ alkyl; each R³ is alkylene; and each R² can be independently hydrogen, an alkyl group, an alkenyl group, a cycloalkyl group, or a heterocyclyl group, and at least one R² is a hydrogen.

Particular examples of useful amino-functional alkoxysilanes include N-((cyclohexylamino)methyl)triethoxysilane, N-((cyclohexylamino)methyl)-diethoxymethylsilane, 3-am nopropyltrimethoxysilane, 3-aminopropyltriethoxysilane, 3-aminopropyldimethoxymethylsilane, N-((cyclohexylamino)methyl)trimethoxysilane, N-phenylaminomethyltrimethoxysilane, and N-phenylaminomethyldimethoxymethylsilane.

The reaction of the isocyanato-functional polydisulfide and the amino-functional alkoxysilane can be performed under solvent- and/or catalyst-free conditions.

For complete capping of the polydisulfide there should be at least an equivalent amount of amine-functional to isocyanato-functional groups. For instance, when the isocyanato-functional polydisulfide has two isocyanato-functional groups (di-functional) and the amine-functional alkoxysilane is a secondary amine having one-functional amino-functional group, the ratio of alkoxysilane to polydisulfide may be at least 2:1. If the amine-functional alkoxysilane is a primary amine, then the ratio of alkoxysilane to polydisulfide may also vary between 1:1 and 2:1. The capping reaction may be carried out at temperatures ranging from, for example, ambient to 90° C.

### Group D

In other non-limiting embodiments, alkoxysilane-functional polydisulfides of the present invention are provided as the reaction product of at least one acryl-functional polydisulfide and at least one thiol-functional alkoxy silane.

Acryl-functional polydisulfides for use in this invention can be prepared from thiol-functional polydisulfides, such as those discussed above in Group A. The acryl-functional polydisulfides of Group D can be formed by extending one or more of the polydisulfides of Structures I or II, wherein the chain extension is generally completed using one or more of the di- or poly-acryl-functional chain extending compounds discussed in connection with Group A. Contrary to the compounds discussed in Groups A and B, however, the thiol-functionality of the thiol-functional polydisulfides should be converted to an acryl-functional arrangement where each polydisulfide has at least one acryl-functional endgroup. Generally, to encourage the acryl-functionality of the polydisulfides, the stoichiometric ratio of the di- or poly-functional acrylate to the thiol-functional polydisulfide is typically greater than 1:1, such as 2:1. By providing the di- or poly-functional acrylate in a molar excess, the thiol-functional polydisulfide can be completely or nearly completely consumed through the reaction, and an acryl-functional, or “capped,” polydisulfide can be formed. Preparation of the acryl-functional polydisulfide can be performed neat or using a solvent piperidine catalyst, and can be carried out at a temperature of, for example, 30-70° C. for between 0.5 and 5.0 hours

Non-limiting examples of useful acryl-functional compounds include those acryl-functional compounds discussed above with respect to Group A.

Reaction of a thiol-functional polydisulfide with an acryl-functional chain extender compound can be carried in the presence of a solvent mixture including, for example, tetrahydrafuran (THF) and piperidine. Other organic solvents that dissolve the reagents (i.e., polydisulfide, acrylate, and catalyst) and that do not interfere with the Michael reaction may be considered. Some suitable solvents include 1,4-dioxane, t-butyl alcohol, ether, ethanol, toluene, ethyl acetate, or mixtures of these solvents.

Suitable thiol-functional alkoxy silanes include, but are not limited to, those alkoxysilanes that conform to the general structure:

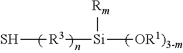

where n is 1-3; m is 0-2; R is C₁₋₆ alkyl or C₆ aryl, which may optionally be substituted by halo, sulfur or oxygen; each R¹ is independently C₁₋₆ alkyl; and each R³ is alkylene, such as C₁-C₆ alkylene.

Some non-limiting examples of suitable thiol-functional alkoxy silanes include mercaptomethylmethyldiethoxysilane, 3-mercaptopropylmethyldimethoxysilane, 3-mercaptopropyltriethoxysilane, 3-mercaptopropyltrimethoxysilane, and 11-mercaptoundecyltrimethoxysilane.

The present invention also comprises a moisture curable sealant composition comprising at least one of the alkoxysilane-functional polydisulfide compounds of the present invention, catalyst, and moisture, i.e., atmospheric or added moisture, or a combination thereof. These compositions may also contain additional additives known in the art to obtain desirable effects for the particular application envisaged. These additives include dyes, inhibitors, viscosity controllers, emulsifiers that are capable of improving the compatibility of all the components, thickeners, plasticizers, diluents, thixotropy conferring agents, and other additives typically used in the adhesives field may be added in the usual manner and quantities to achieve the required viscosity levels and other properties as desired. Cure catalysts include organometallic catalysts, bases, and a combination thereof.

The present invention provides a method of producing bonded composites. The method includes the steps of applying onto at least one substrate an adhesive composition including a moisture curable compound according to the present invention to produce a coated surface on at least one substrate, contacting the coated surface of one substrate and a coated or uncoated surface of another substrate; and exposing the adhesive composition including the moisture curable compound to moisture at a temperature and for a length of time sufficient to produce the bonded composite.

The moisture curable sealants can be used to produce bonded composites and moisture cured adhesive films and articles that can find use in a variety of applications.

The following examples are illustrative of the various embodiments of the present invention and should not be construed as being limiting.

### SYNTHESIS EXAMPLES

In each of the Synthesis Examples provided below, the liquid polysulfide materials, purchased from LP North America Distribution, were used as received with the specification stated in Table 1. Thiol equivalent weights were determined by potentiometric titration.

TABLE 1
Specifications of liquid polydisulfides

| | | Branching | Viscosity | Thiol equivalent |
|---|---|---|---|---|
| Type | Termination | agent [wt-%] | (25° C.) [Pa · s] | weight* [g/eq] |
| LP2 | thiol | 2.0 | 45 | 1931 |
| LP3 | thiol | 2.0 | 1.2 | 503 |
| LP31 | thiol | 0.5 | 130 | 2698 |
| LP55 | thiol | 0 | 45 | 2017 |

Source: Technical data sheets from LP North America Distribution, Inc.
*determined by potentiometric titration (Na₂S₂O₃/I₂)

The general branched structure of these polydisulfides is shown below. LP 55 is prepared without a branching agent and has a linear ditelechelic structure. It can be used to prepare extended linear polymers by reaction with other di-functional compounds.

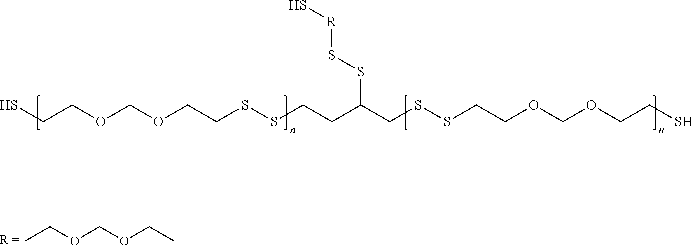

Trithiols Capcure 3-800® and Trimethylolpropane-tris(3-mercapto-propionate), were supplied by Sigma Aldrich and Cognis, respectively. Vinyltrimethoxysilane and Allyltrimethoxysilane, both purchased from Sigma Aldrich, were utilized as received. Free radical initiators, 2,2′-Azobis(4-methoxy-2.4-dimethylvalero-nitrile) (“V70”) and 2,2′-Azobis(2-methylpropionitrile) (AIBN) were supplied by Wako and Aldrich, respectively. Capping agents γ-isocyanatopropyltrimethoxy-silane, N-((cyclohexylamino)methyl)triethoxysilane (“Geniosil XL 926”) and N-((cyclohexylamino)methyl)diethoxymethylsilane (“Geniosil XL 924”) were purchased from Silquest or Wacker Chemie AG. Meta-tetramethyl-xylene diisocyanate (TMXDI) and hexamethylene diisocyanate (HDI) were supplied by Cytec and Fluka. Piperidine was supplied by Sigma Aldrich. Hexanediol diacrylate was purchased from Satomer. Oligomeric diacrylates like polypropylene glycol (900) diacrylate (Sigma Aldrich) and ethoxylated bisphenol a diacrylate (Sartomer) were used as received. Mercaptopropyltrimethoxysilane and mercaptopropylmethyldimethoxysilane were purchased from Sigma Aldrich and Gelest Inc.

### Group A: Reaction Product of a Thiol-Functional Polydisulfide and an Alkenyl-Functional Alkoxy Silane in the Presence of a Free Radical Initiator

### Example 1

### Reaction of Polydisulfide LP-3 and Vinyltrimethoxysilane by Free Radical Thiol-Ene Addition

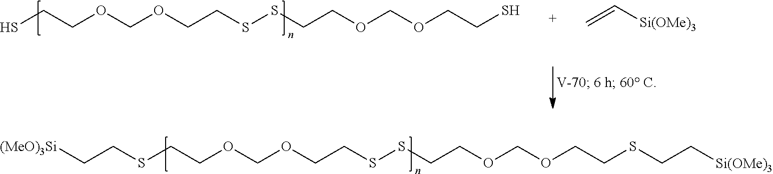

To a 100-mL three-necked reaction flask fitted with a magnetic stirrer, thermocouple and nitrogen inlet was added 183.7 g (0.18 moles) of polydisulfide LP-3, having thiol-equivalent weight 510 g/equivalent and 53.3 g (0.36 moles) of vinyltrimethoxysilane.

The mixture was stirred to give a homogeneous solution, and 2.7 g (0.008 moles) of 2,2′-azobis(4-methoxy-2,4-dimethylvaleronitrile) (“V-70”) was added and dissolved. The headspace was swept with nitrogen and the solution heated to 60° C. during which time bubbles of nitrogen were formed from the decomposition of the azonitrile initiator. Aliquots of the mixture were removed periodically and analyzed for unreacted vinyl by infrared spectroscopy. After six hours, the vinyl group was completely consumed. The reaction mixture cooled and the product, α,ω-bis(trimethoxysilane)-functional polydisulfide, was obtained as a yellow liquid in 97% yield (230.2 g).

The structure of the product was confirmed by spectroscopic and titrimetric analyses:

IR (ATR film) [cm⁻¹]: 2940 (CH₂); 2870 (CH₃); 1465 (CH₂); 1068 (C—O); 1024 (C—O—); 878 (—Si—O).

¹H-NMR (300 MHz; CDCl₃) [ppm]: 4.79-4.73 (m, 12H, O—CH₂—O); 3.86-3.70 (m, 24H, —CH₂—O); 3.58 (m, 18H, O—CH₃); 2.95-2.90 (m, 22H, CH₂—SS); 2.82-2.75 (m, 2H, —CH); 2.74-2.66 (m, 4H, CH₂—S) 1.61 (s, 2H, H₂O); 0.97-1.07 (m, 6H, CH₂—Si).

Thiol content (potentiometric titration, Na₂S₂O₃/I₂): 0.0933 meq/g (4.7% of initial SH).

### Example 2

### Reaction of Polydisulfide LP-3 and Allyltrimethoxysilane by Free Radical Thiol-Ene Addition

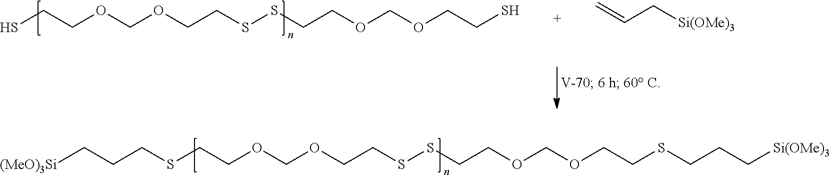

To a three-necked 300-mL reaction flask fitted with nitrogen head-space sweep, magnetic stirrer, heating mantel and thermocouple was added 51.054 g (˜0.05 moles) of polydisulfide LP-3 having thiol-equivalent weight 510 g/equivalent, 16.219 g (0.1 moles) of allyltrimethoxysilane and 0.681 g (2.21 mmoles) of 2,2′-azobis(4-methoxy-2,4-dimethylvaleronitrile). The mixture was stirred and heated. At 45° C., a homogeneous light-yellow colored solution was formed and at 50° C. a strong exothermic reaction occurred driving the temperature to 85° C. The exothermic reaction was accompanied by evolution of nitrogen gas. The mixture was cooled to 60° C. and stirred for five hours during which time the gas evolution ceased. The mixture was cooled and the trimethoxysilane-functional polydisulfide isolated in high yield.

The structure of the product was confirmed by spectroscopic analyses:

IR (ATR film) [cm⁻¹]: 2870-2950 (CH₂, CH₃); 1465 (CH₂); 1068 (C—O); 1024 (C—O—); 878 (—Si—O).

¹H-NMR (300 MHz; CDCl₃) [ppm]: 4.75-4.80 (m, 12H, O—CH₂—O); 3.50-3.90 (m 24H+18H; —CH₂—O and SiO—CH₃); 2.90-2.95 (m, 22H, CH₂—SS); 2.55-2.60 (m, 4H, CH₂—S); 1.65-1.70 (m, 4H; C—CH₂—C); 0.7-0.8 (m, 4H, CH₂—Si).

### Example 3

### Reaction of Polydisulfide LP-2 and Vinyltrimethoxysilane by Free Radical Thiol-Ene Addition

To a 250-mL three-necked reaction flask fitted with mechanical stirrer, thermocouple and nitrogen inlet was added 96.8 g (0.025 moles) of polydisulfide LP-2 having thiol-equivalent weight 1931 g/eq and 7.7 g (0.05 moles) of vinyltrimethoxysilane. The mixture was stirred to give a homogeneous solution and 1.04 g (0.003 moles) of 2,2′-azobis(4-methoxy-2,4-dimethylvaleronitrile) was added and dissolved. The headspace was swept with nitrogen and the solution heated to 60° C., during which time considerable foaming occurred. After six hours at 60° C., iodine/thiosulfate titration indicated that thiol conversion was 35% (quantitative IR analysis was not possible due to low vinyl silane levels). The reaction mixture was cooled and the product, a blend of trimethoxysilane and thiol-functional polydisulfides was obtained as a light brown-yellow viscous liquid (89.5 g; 86% yield).

The structure and composition of the product were determined by spectroscopic and titrimetric analyses:

IR (ATR film) [cm⁻¹]: 2919 (CH₂); 2868 (CH₃); 1598 (C═C); 1465 (CH₂); 1067 (C—O); 1021 (C—O—).

¹H-NMR (300 MHz; CDCl₃) [ppm]: 6.22-5.81 (m, 3H, CH═CH₂); 4.82-4.74 (m, 46H, O—CH₂—O); 3.86-3.68 (m, 92H, —CH₂—O); 3.59 (m, 18H, O—CH₃); 2.95-2.91 (m, 90H, CH₂—SS); 2.82-2.70 (m, 6 μl, —CH); 2.74-2.66 (m, 4H, CH₂—S) 1.59 (m, 3H, H₂O, SH); 0.97-1.07 (m, 6H, CH₂—Si).

Thiol content (potentiometric titration, Na₂S₂O₃/I₂): 0.3394 meq/g (64.7% of initial SH).

### Example 4

### Reaction of Polydisulfide LP-2 and Allyltrimethoxysilane by Free Radical Thiol-Ene Addition

The reaction procedure of Example 3 was repeated using an equivalent amount of allyltrimethoxysilane in place of vinyltrimethoxysilane. After seven hours at 60° C., conversion of thiol to the corresponding trimethoxysilane-functional polydisulfide was estimated to be 36%. The reaction mixture was cooled and the product, a blend of trimethoxysilane and thiol-functional polydisulfides was obtained as a light brown-yellow viscous liquid (102.65 g; 97% yield).

The structure and composition were determined by spectroscopic and titrimetric analyses:

IR (ATR film) [cm⁻¹]: 2919 (CH₂); 2868 (CH₃); 1630 (C═C); 1465 (CH₂); 1067 (C—O); 1021 (C—O—).

¹H-NMR (300 MHz; CDCl₃) [ppm]: 6.22-5.86 (m, 3H, CH═CH₂); 4.81-4.73 (m, 46H, O—CH₂—O); 3.85-3.63 (m, 92H, —CH₂—O); 3.58 (m, 18H, O—CH₃); 2.94-2.90 (m, 90H, CH₂—SS); 2.82-2.70 (m, 2H, —CH); 2.69-2.66 (m, 4H, CH₂—S) 1.58 (m, 3H, H₂O, SH); 0.97-1.07 (m, 6H, CH₂—Si);

Thiol content (potentiometric titration, Na₂S₂O₃/I₂): 0.3336 meq/g (63.6% of initial SH).

### Example 5

### Reaction of Polydisulfide LP-2 and Vinyltrimethoxysilane by Free Radical Thiol-Ene Addition Using Dibenzoylperoxide as a Free Radical Initiator

To a 100 ml three-necked round bottom flask fitted with magnetic stirrer, thermocouple, nitrogen inlet and heating mantel was added 38.62 g (10 mmoles) of polydisulfides LP-2 having a thiol equivalent weight of 1931 g/equivalent and 2.96 g (20 mmoles) of vinyltrimethoxysilane. The mixture was stirred to give a homogeneous solution and 0.416 g (1.72 moles) of dibenzoyl peroxide was added and dissolved. The headspace was swept with nitrogen and the solution heated to 80° C. Aliquots of the mixture were removed periodically and analyzed for unreacted vinyl by infrared spectroscopy. After 4 four hours, 47% of the initial vinyltrimethoxysilane was consumed. The reaction mixture was cooled and the product, a blend of trimethoxysilane and thiol-functional polydisulfides was obtained as a light brown-yellow colored viscous liquid in 88% yield (36.54 g).

The structure and composition were determined by spectroscopic, titrimetric and chromatogrphic analyses:

IR (ATR film) [cm⁻¹]: 2918 (CH₂); 2868 (CH₃); 1600 (C═C); 1465 (CH₂); 1067 (C—O); 1021 (C—O—), 797 (—Si—O).

¹H-NMR (300 MHz; CDCl₃) [ppm]: 4.81-4.74 (m, 46H, O—CH₂—O); 3.85-3.66 (m, 92H, —CH₂—O); 3.58 (m, 18H, O—CH₃); 2.94-2.90 (m, 90H, CH₂—SS); 2.81-2.70 (m, 2H, —CH); 1.55 (m, 3H, H₂O, SH); 1.26 (s,).

Thiol content (potentiometric titration, Na₂S₂O₃/I₂): 0.341 meq/g (64.9% of initial SH).

### Example 6

### Reaction of Polydisulfide LP-2 and Vinyltrimethoxysilane in Ethyl Acetate

To a 500 ml three necked round bottom flask equipped with mechanical stirrer, nitrogen inlet, thermocouple and heating mantel, was added 8.113 g (0.05 moles) vinyltrimethoxysilane, 69.59 g (0.025 moles) of polydisulfide LP-2, and 105 g of ethyl acetate. 2.1 g (7 mmoles) of 2,2′-Azobis(4-methoxy-2.4-dimethylvaleronitrile) was added and dissolved. The headspace was swept with nitrogen and the solution heated up 60° C. during which time considerable foaming occurred. Aliquots of the mixture were removed periodically and analyzed for unreacted vinyl by infrared spectroscopy. After six hours, 38% of the initial vinyltrimethoxysilane was consumed. The reaction was cooled and the solvent removed by distillation on a rotary evaporator (15 mbar, 30° C.). The product, consisting of a blend of trimethoxysilane and thiol functional polydisulfides was obtained as a yellow, viscous liquid in 98% yield (102.00 g).

The structure and composition were determined by spectroscopic and titrimetric analyses:

IR (ATR film) [cm⁻¹]: 2937 (CH₂); 2870 (CH₃); 1735 (C═O) 1598 (C═C); 1465 (CH₂); 1070 (C—O); 1021 (C—O—); 878 (—Si—O).

¹H-NMR (300 MHz; CDCl₃) [ppm]: 6.25-5.89 (m, 3H, CH═CH₂); 4.85-4.77 (m, 46H, O—CH₂—O); 3.89-3.69 (m, 92H, —CH₂—O); 3.62-3.61 (m, 18H, O—CH₃); 2.98-2.94 (m, 90H, CH₂—SS); 2.84-2.72 (m, 21-1, —CH); 2.71-2.68 (m, 4H, CH₂—S); 1.66-1.60 (m, 3H, H₂O, —SH; 0.97-1.07 (m, 6H, CH₂—Si).

Thiol content (potentiometric titration, Na₂S₂O₃/I₂): 0.256 meq/g (49% of initial SH).

A summary of the results of Examples 1-5 is presented in Table 2, below. All thiol conversions were calculated using the titrimetric determined thiol-content before and after the reaction, according to the equation:

$$conversion [ \% ] = 100 - ( \frac{wt - \% {( SH )}_{after}}{wt - \% {( SH )}_{before}} \times 100 )$$

TABLE 2
Summary of Examples 1-5

| | | | Reaction | Conversion |
|---|---|---|---|---|
| Ex.. | Starting materials a) | Catalysts | conditions | [%]* |
| 1 | LP3 (MW = 1000 g/mol) | 2,2′-Azobis(4-methoxy-2.4- | 4 h; 55° C.; bulk | 95.3 |
| | Vinyltrimethoxysilane | dimethylvalero-nitrile) | | |
| | | (1.6 mol-%) | | |
| 2 | LP 2 (MW = 4000 g/mol) | 2,2′-Azobis(4-methoxy-2.4- | 4 h; 55° C.; bulk | 35.3 |
| | Vinyltrimethoxysilane | dimethylvalero-nitrile) | | |
| | | (3.8 mol-%) | | |
| 3 | LP2 | 2,2′-Azobis(4-methoxy-2.4- | 6 h; 60° C.; | 51.2 |
| | Vinyltrimethoxysilane | dimethylvalero-nitrile) | in Ethylacetate | |
| | | (8.5 mol-%) | | |
| 4 | LP2 | Dibenzoylperoxide | 4 h; 80° C.; bulk | 35.1 |
| | Vinyltrimethoxysilane | (2.6 mol-%) | | |
| 5 | LP2 | 2,2′-Azobis(4-methoxy-2.4- | 7 h; 55° C.; bulk | 36.4 |
| | Allyltrimethoxysilane | dimethylvalero-nitrile) | | |
| | | (4.6 mol-%) | | |

*conversion determined by iodometric titration of the residue thiol-groups
a) LP3: Liquid polydisulfide, molecular weight approx. 1100 g/mol, crosslinking 2.0%, LP2: Liquid polydisulfid, molecular weight 4000 g/mol, crosslinking 2.0%

The LP3 polymer having a molecular weight of approximately 1000 g/mol yielded high conversions. In contrast, the higher molecular weight polymer LP2 (approximately 4,000 g/mol), did not yield high conversions in reactions with vinyltrimethoxysilane. In this case, strong foaming occurred during the reaction from nitrogen gas liberated during the decomposition of the azonitrile initiator, which may have contributed to low conversion due to a lowering of the reaction temperature and a consequent reduction in rate.

A similar result was obtained in the reaction between LP2 and the more reactive allyltrimethoxysilane, to avoid the formation of nitrogen and associated foaming, benzoyl peroxide was used as an alternative radical initiator. However, only partial conversion was also observed in this case. Peroxide initiators, also used as curing agents for thiol-functional, liquid polysulfides, may cause oxidation of thiol as a side reaction. All reactions were accomplished with equivalent stoichiometry. An excess of vinyl compound might accelerate reaction towards the product.

A quantitative determination of residual thiol and vinyl groups could not be accomplished for LP2 and other high molecular weight polydisulfides, since the characteristic thiol absorption at 2564 cm⁻¹ is relatively weak and its strength decreases with increasing molecular weights of the polydisulfides. The vinyl absorbance at 1599 cm⁻¹ also weakens with increasing molecular weight of the polysulfide, since the initial amount of the vinyl-compound is only a fourth of the amount used in LP3-VTMS adducts. For this reason, thiol conversion was determined by titrimetric methods.

The described thiol-ene synthesis demonstrates that alkoxysilane-functional polysulfides and related materials can be obtained through thiol-ene addition, via a bulk reaction process. Quantitative conversions of thiol were readily achieved for low molecular weight polymers, but only partial conversion for the higher molecular weight materials. The process is highly attractive from both ecological and economic standpoints, since neither product purification nor reaction solvents are necessary.

### Group B: Reaction Product of a Thiol-Functional Polydisulfide and an Isocyanato-Functional Alkoxysilane

### Example 7

### Reaction of Polydisulfide LP-2 and γ-Isocyanatopropyltrimethoxysilane Through Thiol-Isocyanate Addition

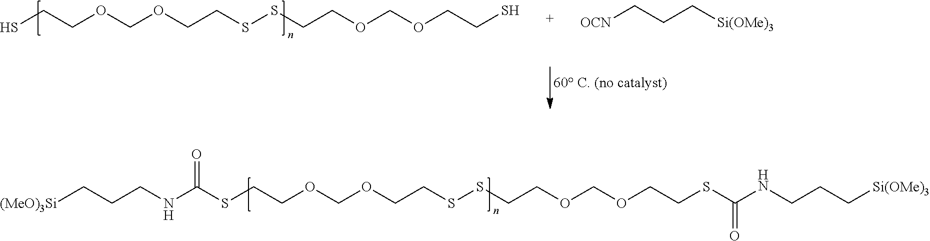

241.50 g (63 mmoles) of polydisulfide LP-2, having a thiol-equivalent weight of 1931 g/equivalent, was added to a 500-ml three-necked round bottom flask fitted with mechanical stirrer, thermocouple, nitrogen inlet, and heating mantel. 25.71 g (0.125 moles) of the equivalent of γ-isocyanatopropyltrimethoxysilane was added and the mixture stirred to give a homogeneous solution. The headspace was swept with nitrogen and the solution heated up to 60° C., during which time slight foaming was observed at the surface of the mixture. Aliquots of the mixture were removed periodically and analyzed for unreacted isocyanate by infrared spectroscopy (disappearance of absorbance band due to —NCO group at 2251 cm⁻¹). After four hours the isocyanate was completely consumed. The reaction was cooled and the required α,ω-bis(trimethoxysilane)-functional thiocarbamate-polydisulfide isolated as a yellow-brown liquid in 97% yield (260.28 g).

The structure of the product was confirmed by spectroscopic and titrimetric analyses:

IR (ATR film) [cm⁻¹]: 3331 (—NH); 2921 (—CH₂); 2868 (—CH₃); 1679 (C═O), 1465 (CH₂); 791 (Si—O).

¹H-NMR (300 MHz; CDCl₃) [ppm]: 4.82-4.73 (m, 46H, O—CH₂—O); 3.86-3.61 (m, 92H, —CH₂—O); 3.58-3.57 (m, 18H, O—CH₃); 3.15-3.13 (t, 2H, NH); 2.94-2.90 (m, 90H, CH₂—SS); 2.82-2.70 (m, 2H, —CH); 2.69-2.66 (m, 4H, CH₂—S); 1.58 (m, 3H, H₂O); 0.68-0.63 (m, 6H, CH₂—Si).

Thiol content (potentiometric titration, Na₂S₂O₃/I₂): 0.09 meq/g (83% of initial SH).

### Example 8

### Reaction of Polydisulfide LP-31 and γ-Isocyanatopropyltrimethoxysilane Through Thiol-Isocyanate Addition

The procedure of Example 7 was repeated using 269.89 g (0.05 moles) of polydisulfide LP-31 having a thiol equivalent weight of 2698 g/equivalent in place of polydisulfide LP-2 and an equivalent amount (20.53 g; 0.1 moles) of γ-isocyanatopropyltrimethoxysilane. After eight hours at 60° C., the isocyanate was completely consumed, as indicated by IR. The mixture was cooled and the trimethoxysilane-functional polysulfide obtained as a yellow-brown, viscous liquid in 84% yield (242.00 g).

The structure was confirmed by spectroscopic and titrimetric analyses:

IR (ATR film) [cm⁻¹]: 3331 (—NH); 2919 (—CH₂); 2868 (—CH₃); 1681 (C═O), 1465 (CH₂); 789 (Si—O)

¹H-NMR (300 MHz; CDCl₃) [ppm]: 4.82-4.72 (m, H, O—CH₂—O); 3.86-3.61 (m, H, —CH₂—O); 3.58-3.57 (m, 18H, O—CH₃); 3.16-3.13 (t, 2H, NH); 2.94-2.90 (m, H, CH₂—SS); 2.80-2.75 (m, 2H, —CH); 1.58 (m, 3H, H₂O); 0.69-0.63 (m, 6H, CH₂—Si).

Thiol content (potentiometric titration, Na₂S₂O₃/I₂): 0.203 meq/g (83% of initial SH).

### Example 9

### Reaction of Polydisulfide LP-55 and Hexamethylene Diisocyanate Capped with γ-Isocyanatopropyltrimethoxysilane Through Thiol-Isocyanate Addition

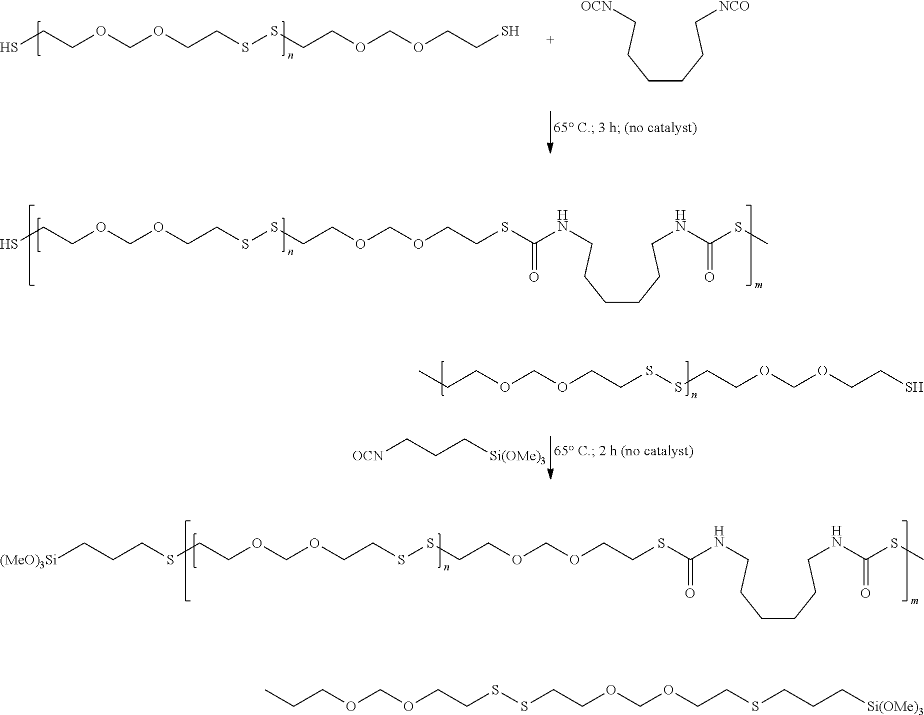

This example represents a two-step reaction process in which an extended, thiol-functional polydisulfide is prepared in a first step from a molar excess of a thiol-functional polydisulfide material and a diisocyanate. In the second step, an alkoxysilane-functional polydisulfide is formed as the reaction product of the thiol-functional polydisulfide and an isocyanato-functional alkoxysilane. The subscript m represents the number average degree of polymerization based on the ratio of diisocyanate to the thiol-functional polydisulfide. The value of m is about 2 assuming full conversion.

In the first step, 179.6 g (45 mmoles) of polydisulfide LP-55 having a thiol equivalent weight of 2017 g/equivalent and 4.812 g (30 mmoles) of hexamethylene diisocyanate (“HDI”) were added to a 500 ml three-necked round bottom flask fitted with mechanical stirrer, thermocouple, nitrogen inlet and heating mantel. The headspace was swept with nitrogen and stirred solution heated up to 65° C. Aliquots of the mixture were removed periodically and analyzed for unreacted isocyanate by infrared spectroscopy. After three hours, the isocyanate was completely consumed, indicating quantitative formation of the intermediate thiol-functional thiocarbamate-extended polydisulfide. In the second step, 6.10 g (0.03 moles) of γ-isocyanatopropyltrimethoxysilane was added and the mixture stirred for an additional two hours, at which time the infrared spectrum indicated complete consumption of the capping agent. The mixture was cooled and the product, α,ω-bis(trimethoxysilane)-functional thiocarbamate-extended polydisulfide, was obtained as a yellow, viscous liquid (242.00 g; 84% yield).

The structure was confirmed by spectroscopic and chromatographic analyses:

IR (ATR film) [cm⁻¹]: 3331 (—NH); 2924 (—CH₂); 2867 (—CH₃); 1687 (C═O), 831 (Si—O).

¹H-NMR (300 MHz; CDCl₃) [ppm]: 4.81-4.72 (m, 46H, O—CH₂—O); 3.85-3.61 (m, 92H, —CH₂-0); 3.58 (m, 18H, O—CH₃); 3.16-3.12 (t, 6H, NH); 2.94-2.90 (m, 90H, CH₂—SS); 2.81-2.77 (m, 2H, —CH); 1.55 (m, 3H, H₂O); 0.68-0.62 (m, 6H, CH₂—Si).

GPC (THF; PMMA standards): Mₙ=20840; M_{w}=68072; PDI=3.27.

### Example 10

### Reaction of Polydisulfide LP-55 and Hexanediol Diacrylate Capped with γ-Isocyanato-Propyltrimethoxysilane Through Michael Addition

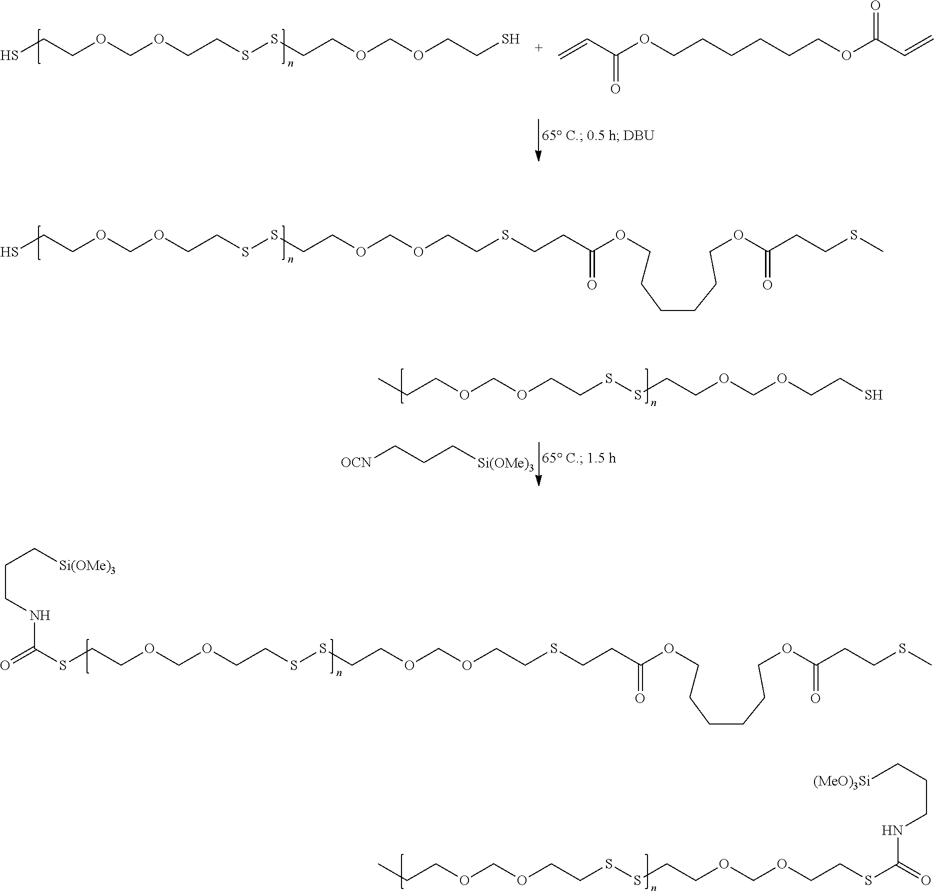

This example represents a two-step reaction process. In the first step, an extended thiol-functional polydisulfide is prepared from a thiol-functional polydisulfide material and a diacrylate material, where the polydisulfide is provided in a molar excess. In the second step, an alkoxysilane-functional polydisulfide is formed as the reaction product of the thiol-functional polydisulfide and an isocyanato-functional alkoxysilane.

In the first step, 198.08 g (50 mmoles) of polydisulfide LP-55 having a thiol equivalent weight of 2017 g/equivalent and 5.56 g; 25 mmoles of hexanediol diacrylates (“HDDA”) were added to a 500 ml three-necked round bottom flask fitted with mechanical stirrer, thermocouple, nitrogen inlet and heating mantel. 1.031 g of triethylamine was added as a catalyst for Michael addition and dissolved. The headspace was swept with nitrogen and stirred solution heated up to 65° C. Aliquots of the mixture were removed periodically and analyzed for unreacted acrylate by infrared spectroscopy, which confirmed that no reaction had taken place after three hours. 1.036 g of 1,8-Diazabicyclo[5.4.0]undec-7-en (“DBU”) was then added to the solution. The reaction was continued for an additional 0.5 hours, during which time the viscosity increased and a dark red color developed. IR analysis showed complete conversion of the acrylate (disappearance of absorbance band at 1635 cm⁻¹) indicating quantitative formation of thiol functional polydisulfide thiopropionate ester. In a second step, 11.08 g (0.05 moles) of γ-isocyanato-propyltrimethoxysilane was then added and the mixture was stirred for an additional 1.5 hours, after which time the absorbance band in the IR spectrum due to the isocyanate group had completely disappeared (2251 cm⁻¹). The mixture was cooled and the required product, α,ω-bis(trimethoxysilane)-functional polydisulfide, isolated as dark-red, viscous liquid in 96% yield (206.52 g).

The structure was confirmed by spectroscopic and chromatographic analyses:

IR (ATR film) [cm⁻¹]: 3336 (—NH); 2920 (—CH₂); 2868 (—CH₃); 1730 (C═O ester), 1679 (C═O thiocarbamate), 809 (Si—O).

¹H-NMR (300 MHz; CDCl₃) [ppm]: 4.81-4.74 (m, 46H, O—CH₂—O); 4.12-4.07 (t, 4H, CH₂—O—C═O)_{3.85}-3.61 (m, 92H, —CH₂—O); 3.58 (m, 18H, O—CH₃); 2.94-2.90 (m, 90H, CH₂—SS); 2.85-2.74 (m, 2H, —CH); 2.64-2.62 (t, 4H, CH₂—C═O); 1.71-1.61 (m, 4H, CH₂ propyl), 1.55 (m, 3H, H₂O); 1.42-1.38 (m, CH₂ hexyl); 0.68-0.62 (m, 6H, CH₂—Si).

GPC (THF; PMMA standards): Mₙ=12666; M_{w}=27232; PDI=2.15.

### Group C: Reaction Product of a Isocyanato-Functional Polydisulfide and an Amino-Functional Alkoxysilane

### Example 11

### Reaction of Polydisulfide LP-55 and Meta-Tetramethylxylene Diisocyanate Capped with N-((Cyclohexylamino)Methyl)Triethoxylsilane Through Thiol-Isocyanate Addition

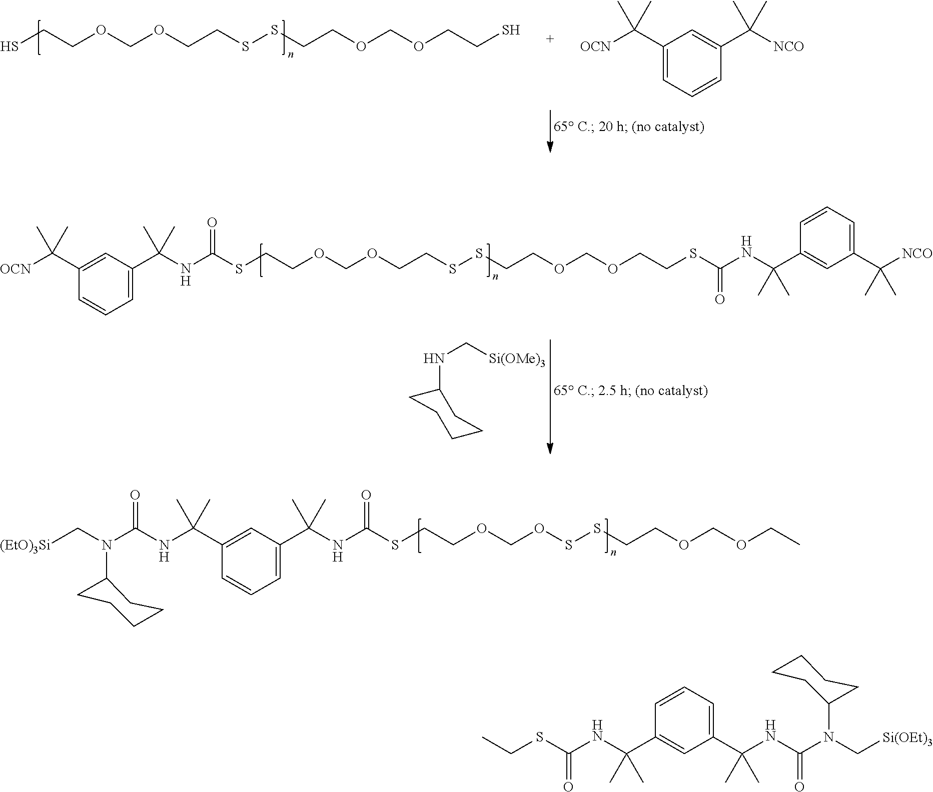

This example represents a two-step reaction process. In the first step, a thiol-functional polydisulfide is prepared from a thiol-functional polydisulfide material and a diisocyanate material provided in a molar excess (2:1). In the second step, an alkoxysilane-functional polydisulfide is formed as the reaction product of the thiol-functional polydisulfide and an amino-functional alkoxysilane.

In the first step, 285.94 g (0.07 moles) of polydisulfide LP-55 having a thiol equivalent weight of 2017 g/equivalent and 34.64 g (0.14 moles) of meta-tetramethylxylene diisocyanate (“m-TMXDI”) were added to a 500 ml three-necked round bottom flask fitted with mechanical stirrer, thermocouple, nitrogen inlet, and heating mantel. The headspace was swept with nitrogen and the stirred solution heated to 65° C. Aliquots of the mixture were removed periodically and analyzed for unreacted isocyanate by infrared spectroscopy. After twenty hours, 50% of the original isocyanate was consumed indicating quantitative formation of the isocyanate-functional intermediate thiocarbamate polydisulfide (integration of absorbance band due to —NCO group at 2251 cm⁻¹).

In a second step, 39.07 g (0.14 moles) of N—((Cyclohexylamino)methyl)triethoxysilane was added dropwise to the stirred solution and the reaction continued for additional 2.5 hours, after which time complete consumption of the isocyanate was observed. The mixture was cooled and the required product, α,ω-bis(triethoxysilane)-functional thiocarbamate-carbamate, obtained as a yellow, cloudy, viscous liquid (345.2 g; 96% yield).

The structure was confirmed by spectroscopic and chromatographic analyses:

IR (ATR film) [cm⁻¹]: 3356 (—NH); 2925 (—CH₂); 2867 (—CH₃); 1689 (C═O; thiocarbamate 1638 (C═O; urea), 848 (Si—O).

¹H-NMR (300 MHz; CDCl₃) [ppm]: 4.81-4.70 (m, 46H, O—CH₂—O); 3.85-3.67 (m, 92H, —CH₂—O); 3.66-3.64 (m, 18H, O—CH₃); 2.94-2.88 (m, 90H, CH₂—SS); 2.79-2.77 (m, 2H, —CH); 2.63-2.58 (d, 4 μl, CH₂—S—C═O); 1.70-1.66 (m, 4HN—CH₂—Si), 1.55 (m, 3H, H₂O); 1.25-117 (m, 24H, CH₃—C—).

GPC (THF; PMMA standards): Mₙ=6637; M_{w}=21476; PDI=3.24.

### Example 12

### Reaction of Polydisulfide LP-55 and M-Tetramethylxylene Diisocyanate (M-TMXDI) Capped with N-((Cyclohexylamino)Methyl)Diethoxymethylsilane Through Thiol-Isocyanate Addition

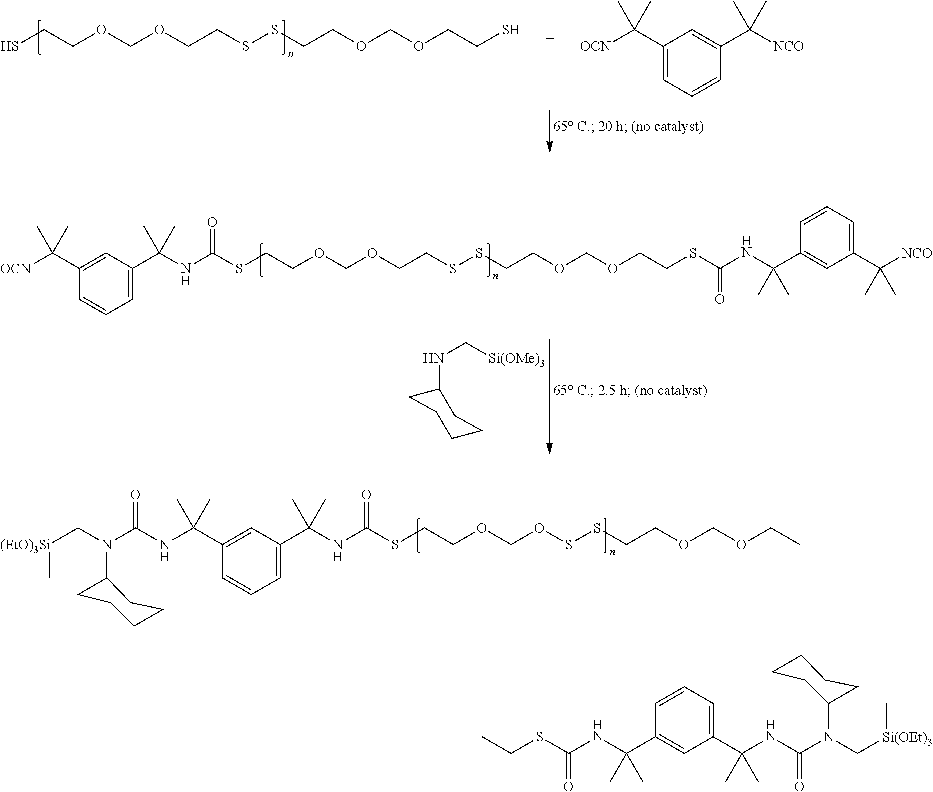

The procedure of Example 11 was repeated using the 29.94 g (120 mmoles) of the capping agent N-(cyclohexylamino)methyl)diethoxymethyl-silane in place of N-(cyclohexylamino)methyl)triethoxy-silane. After twenty-two hours at 55° C., the intermediate diisocyanate-functional polydisulfide was fully formed (52% of initial isocyanate consumed) and the capping agent was added. After twenty-three and a half hours at 55° C., all of the remaining isocyanate had reacted. The reaction mixture was cooled and the required α,ω-bis(diethoxymethylsilane)-functional thiocarbamate-urea obtained as a yellow, cloudy, viscous liquid in 95% yield (292.5 g).

The structure was confirmed by spectroscopic and chromatographic analyses:

IR (ATR film) [cm⁻¹]: 3356 (—NH); 2924 (—CH₂); 2867 (—CH₃); 1689 (C═Othiocarbamate), 1638 (C═O urea), 831 (Si—O).

¹H-NMR (300 MHz; CDCl₃) [ppm]: 44.79-4.70 (m, 46H, O—CH₂—O); 3.85-3.70 (m, 92H, —CH₂—O); 3.66-3.63 (m, 18H, O—CH₃); 2.94-2.84 (m, 90H, CH₂—SS); 2.79-2.76 (m, 2H, —CH); 2.63-2.53 (d, 4H, CH₂—S—C═O); 1.70-1.66 (m, 4HN—CH₂—Si), 1.55 (m, 3H, H₂O); 0.68-0.62 (m, 6H, CH₂—Si), 1.24-1.17 (m, 24H, CH₃—C—), 0.34 (s, 6H, CH₃—Si).

GPC (THF, PMMA standards): Mₙ=6622; M_{w}=20587; PDI=3.11.

### Group D: Reaction Product of an Acryl-Functional Polydisulfide and a Thiol-Functional Alkoxy Silane

### Example 13

### Reaction of Polydisulfide LP-55 and Hexanediol Diacrylate (2:3 Mole Ratio) Capped with γ-Mercaptopropyl-Trimethoxysilane Through Michael Addition

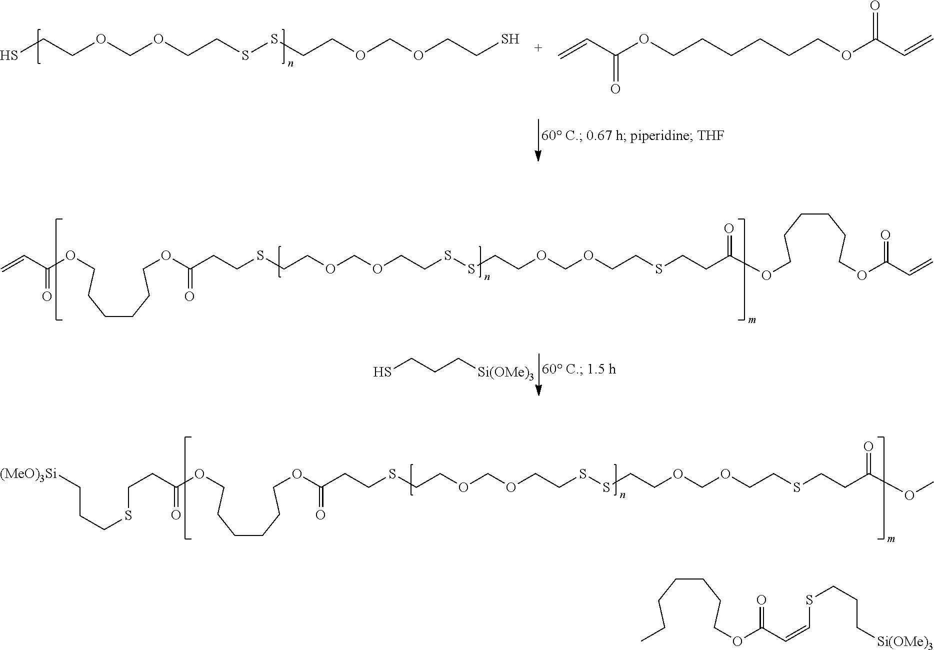

In this two step mechanism, a acryl-functional polydisulfide is prepared from reacting a thiol-functional polydisulfide material and a di(acryl-functional) material. An alkoxysilane-functional polydisulfide is then formed by reacting the acryl-functional polydisulfide and a thiol-functional alkoxysilane. The subscript m represents the number average degree of polymerization based on the ratio of di(acryl-functional) material to the thiol-functional polydisulfide. The value of m is about 2, assuming full conversion.

In a first step, to a 500 ml three-necked round bottom flask fitted with mechanical stirrer, thermocouple, nitrogen inlet and heating mantel were added 161.28 g (40 mmoles) of polydisulfide LP-55, having a thiol equivalent weight of 2017 g/equivalent, 120 g of THF, 13.56 g (60 mmoles) of hexanediol diacrylate, and 0.9 g (11 mmoles) of piperidine. The mixture was stirred to give a homogeneous solution. During the addition of piperidine, an exothermic reaction was observed. The headspace was swept with nitrogen and the stirred solution heated to 60° C. Aliquots of the mixture were removed and analyzed for unreacted acrylate by infrared spectroscopy. After forty minutes 68% of the initial acrylate was consumed, indicating quantitative formation of intermediate α,ω-diacrylate functional polydisulfide extended polyester. An equivalent amount (7.856 g; 40 mmoles) of mercaptopropyltrimethoxysilane was added dropwise. After stiffing for an additional 1.5 hours infrared spectroscopy indicated complete consumption of acrylate (disappearance of absorbance band at 1635 cm⁻¹). The solvent was removed under reduced pressure (13 mbar; 50° C.) to yield the required α,ω-bis(trimethoxysilane)-functional polydisulfide extended polyester as a yellow liquid in 94% yield (172.03 g).

The structure was confirmed by spectroscopic and chromatographic analyses:

IR (ATR film) [cm⁻¹]: 2929 (—CH₂); 2866 (—CH₃); 1732 (C═O), 1465 (CH₂), 831 (Si—O).

¹H-NMR (300 MHz; CDCl₃) [ppm]: 4.81-4.73 (m, 46H, O—CH₂—O); 4.12-4.08 (m, CH₂—O—C═O); 3.87-3.66 (m, 92H, —CH₂—O); 3.57 (m, 18H, O—CH₃) 2.96-2.86 (m, 90H, CH₂—SS); 2.85-2.69 (m, 2H, —CH); 2.66-2.59 (t, 12H, CH₂—C═O); 1.63-1.60 (m, 6H, CH₂—CH₂); 1.57 (H₂O); 1.47-1.37 (m, 6H, CH₂—CH₂); 0.78-0.71 (m, 6H, CH₂—Si).

GPC (THF; PMMA standards): Mₙ=7864; M_{w}=30539; PDI=3.88.

### Example 14

### Reaction of Polydisulfide LP-55 and Hexanediol Diacrylate Capped with γ-Mercaptopropyl-Dimethoxymethylsilane Through Michael Addition

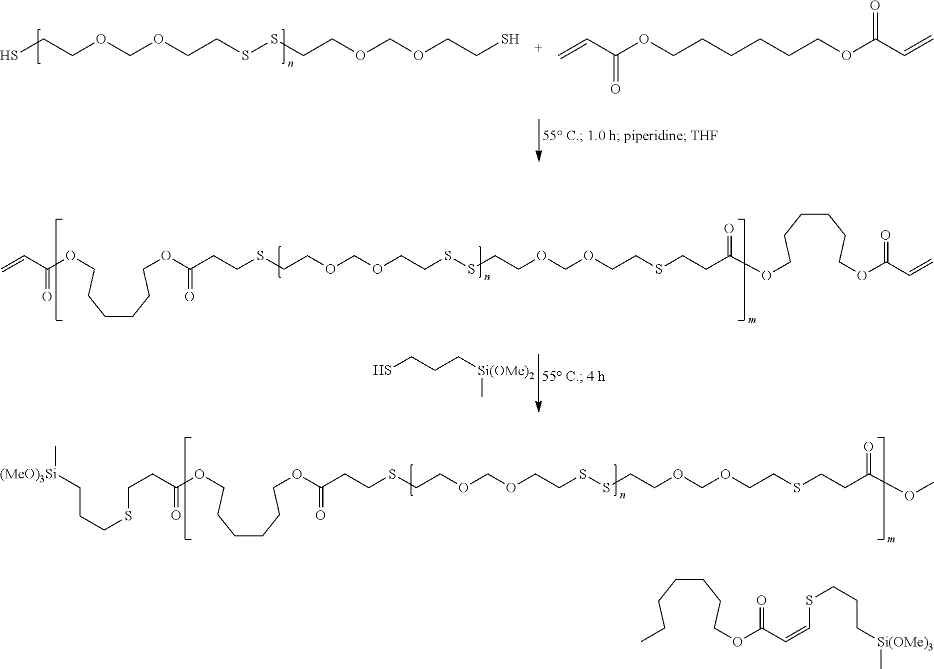

The procedure of Example 13 was repeated, but γ-mercaptopropyltrimethoxysilane was replaced with γ-mercaptopropyldimethoxymethylsilane as the capping agent. The intermediate diacrylate was formed after one hour at 55° C. (IR analysis indicated 74% consumption of acrylate). 7.21 g (40 mmoles) of γ-mercaptopropyldimethoxymethylsilane was added and the mixture stirred for an additional four hours, after which time all of the acrylate had been consumed. The mixture was cooled and the solvent removed under reduced pressure using a rotary evaporator (16 mbar, 40° C.; 1 h, 0.48 mbar, RT). The required product, α,ω-bis(diethoxymethylsilane)-functional polydisulfide extended polyester, was obtained as a yellow liquid in 95% yield (172.3 g).

The structure of the product was confirmed by spectroscopic and chromatographic analyses:

IR (ATR film) [cm^{-I}]: 2924 (—CH₂); 2867 (—CH₃); 1732 (C═O), 1465 (CH₂), 834 (Si—O).

¹H-NMR (300 MHz; CDCl₃) [ppm]: 4.81-4.73 (m, 46H, O—CH₂—O); 4.12-4.07 (m, 12H, CH₂—O—C═O); 3.85-3.64 (m, 92H, —CH₂—O); 3.51 (m, 18H, O—CH₃) 2.94-2.90 (m, 90H, CH₂—SS); 2.86-2.69 (m, 2H, —CH); 2.64-2.59 (t, 12H, CH₂—C═O); 1.69-1.59 (m, 6H, CH₂—CH₂); 1.54 (H₂O); 1.45-1.33 (m, 6H, CH₂—CH₂); 0.76-0.70 (m, 6H, CH₂—Si).

GPC (THF; PMMA standards): Mₙ=5406; M_{w}=13079; PDI=2.4.

### Example 15

### Reaction of Polydisulfide Lp-55 and Polypropyleneglycol (900) Diacrylate Capped with Mercaptopropyltrimethoxysilane Through Michael Addition

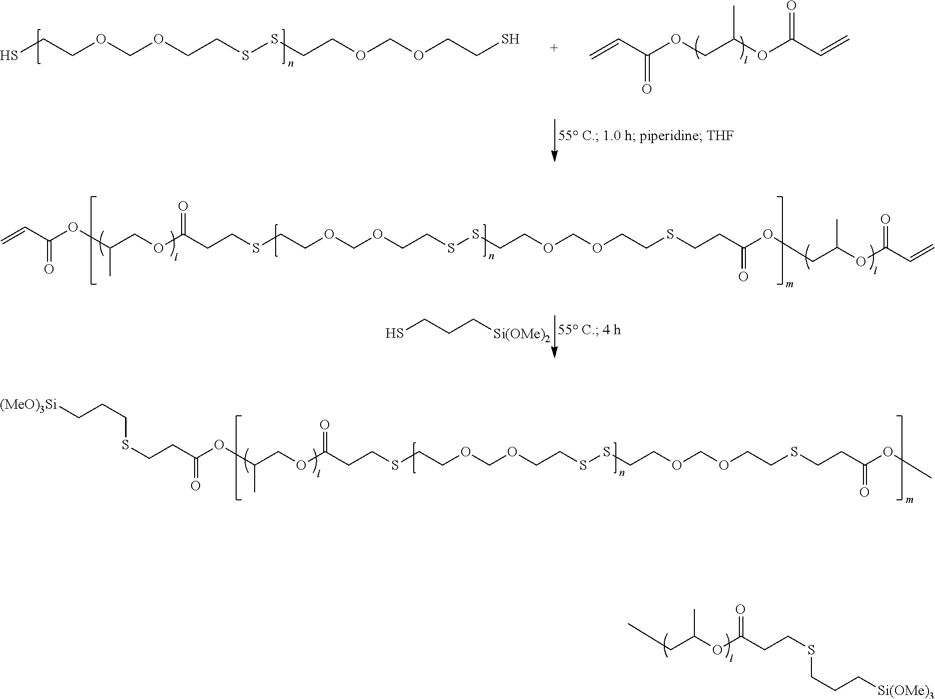

In the first step of a two-step process, an acryl-functional polydisulfide is prepared by reacting a thiol-functional polydisulfide material and a di(acryl)-functional material. An alkoxysilane-functional polydisulfide is then prepared by reacting the acryl-functional polydisulfide and a thiol-functional alkoxysilane. The subscript m represents the number average degree of polymerization based on the ratio of di(acryl-functional) material to the thiol-functional polydisulfide. The value of m is about 2, assuming full conversion.

To a 500 ml three-necked round bottom flask fitted with mechanical stirrer, thermocouple, nitrogen inlet and heating mantel was added 161.28 g (40 mmoles) of polydisulfide LP-55 having a thiol equivalent weight of 2017 g/equivalent, 120 g of THF, 48.54 g (60 mmoles) of polypropyleneglycol (900) diacrylate, and 1.2 g (6 mmoles) of piperidine. The mixture was stirred to give a homogeneous solution. During the addition of piperidine, an exothermic reaction was observed. The headspace was swept with nitrogen and the stirred solution heated to 60° C. Aliquots of the mixture were removed and analyzed for unreacted acrylate by infrared spectroscopy. After two hours 82% of the initial acrylate was consumed, indicating quantitative conversion to intermediate diacrylate functional alternating polypropyleneoxide-polydisulfide copolymer. An excess of mercaptopropyltrimethoxysilane (7.856 g; 40 mmoles) was then added dropwise and the mixture stirred for an additional one and a half hours, after which time infrared spectroscopy indicated complete consumption of the acrylate. The reaction was cooled and the solvent was removed under reduced pressure (rotary evaporator: 13 mbar; 40° C.; 1 h, 0.48, RT). The α,ω-bis(trimethoxysilane)-functional polydisulfide-hybrid copolymer was obtained as a yellow, viscous liquid (201.76 g; 93% yield).

The structure was confirmed by spectroscopic and chromatographic analyses:

IR (ATR film) [cm⁻¹]: 2924 (—CH₂); 2868 (—CH₃); 1730 (C═O), 1462 (CH₂), 810 (Si—O).

¹H-NMR (300 MHz; CDCl₃) [ppm]: 6.42-6.38, 6.18-6.12, 5.84-5.78 (m, CH═CH₂) 4.81-4.73 (m, 46H, O—CH₂—O); 3.85-3.63 (m, 92H, —CH₂—O); 3.58 (m, 18H, O—CH₃) 2.94-2.90 (m, 90H, CH₂—SS); 2.85-2.72 (m, 2H, —CH); 1.55 (H₂O); 1.28-1.22 (m, 72H, CH₂—CH₂); 0.76-0.70 (m, 6H, CH₂—Si).

GPC (THF; PMMA standards): Mₙ=7097; M_{w}=17521; PDI=2.47.

### Example 16

### Reaction of Polydisulfide LP-55 with Ethoxylated Bisphenol a Diacrylate Capped with γ-Mercaptopropyltrimethoxysilane

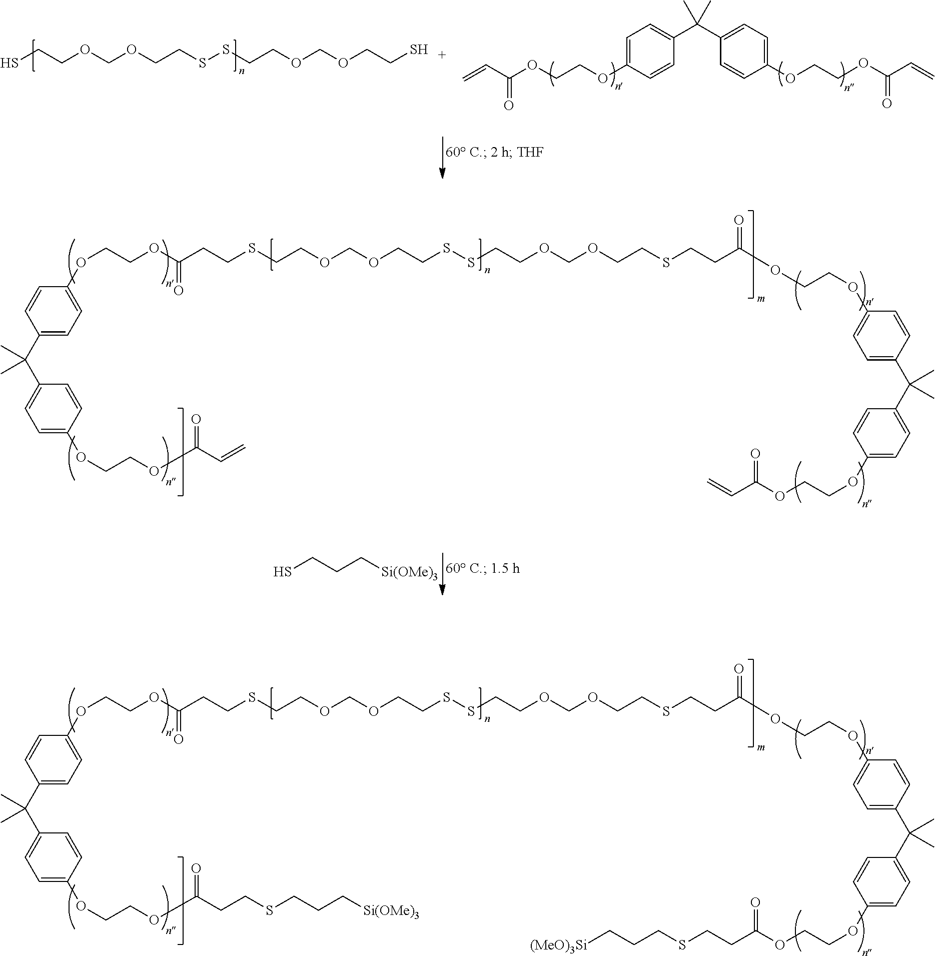

In the first step of a two-step process, an acryl-functional polydisulfide is prepared by reacting a thiol-functional polydisulfide material and a di(acryl-functional) material. An alkoxysilane-functional polydisulfide is then prepared by reacting the acryl-functional polydisulfide and a thiol-functional alkoxysilane. The subscript m represents the number average degree of polymerization based on the ratio of di(acryl-functional) material to the thiol-functional polydisulfide. The value of m is about 2, assuming full conversion.

To a 500 ml three-necked round bottom flask fitted with mechanical stirrer, thermocouple, nitrogen inlet, and heating mantel was added 120.96 g (30 mmoles) of polydisulfide LP-55, having a thiol equivalent weight of 2017 g/equivalent, 120 g of THF, 74.52 g (45 mmoles) of ethoxylated bisphenol A diacrylate, and 1.2 g (6 mmoles) of piperidine. The mixture was stirred to give a homogeneous solution. During the addition of piperidine, an exothermic reaction was observed. The headspace was swept with nitrogen and the stirred solution heated to 60° C. An aliquot of the mixture was removed and analyzed for unreacted acrylate by infrared spectroscopy. After two hours 68% of the initial acrylate was consumed indicating quantitative formation of acrylate-functional intermediate polymer. An equivalent amount (7.856 g; 0.04 moles) of γ-mercaptopropyltrimethoxysilane was then added dropwise. After one and a half hours, infrared spectroscopy indicated complete consumption of the acrylates. The reaction was cooled the solvent removed under reduced pressure (rotary evaporator: 13 mbar; 40° C.; 1 h, 0.48, RT). The hybrid α,ω-bis(trimethoxysilane)-functional polydisulfide-polyether was obtained as a yellow, viscous liquid in 92% yield (185.3 g).

The structure was confirmed by spectroscopic and chromatographic analyses:

IR (ATR film) [cm⁻¹]: 2924 (—CH₂); 2867 (—CH₃); 1733 (C═O), 1462 (CH₂), 831 (Si—O).

¹H-NMR (300 MHz; CDCl₃) [ppm]: 7.13-7.11 (d, 2H, phenol); 6.81-6.79 (d, 2H, phenol); 4.81-4.73 (m, 46H, O—CH₂—O); 4.27-4.24 (m, 12H, CH₂—O—C═O); 4.11-4.08 (m, 12H, CH₂—O-phenol); 3.85-3.66 (m, 92H, —CH₂—O); 3.64 (m, 180H, CH₂—O); 3.58 (m, 18H, 0-CH₃) 2.94-2.90 (m, 90H, CH₂—SS); 2.84-2.68 (m, 2H, —CH); 2.64-2.62 (m, 12H, CH₂—C═O), 1.62-1.59 (s, 27H, CH₃); 1.57 (H₂O); 0.75-0.73 (m, 6H, CH₂—Si).

GPC (THF; PMMA standards): Mₙ=6299; M_{w}=12514; PM=1.99.

### Preparation of the TMMP/VTMS Adduct

An adduct prepared by the reaction of trimethylolpropane tris-3-mercaptopropionate (“TMMP”) and vinyltrimethoxysilane (“VTMS”) was also explored. This adduct is used in the below formulations of moisture curable sealants.

The thiol-ene addition reaction of vinyl-TMS and trimethylolpropane tris-3-mercaptopropionate (TMMP) was successfully completed to high conversion. This low molecular weight alkoxysilane may be used as a reactive additive in moisture cured formulations for viscosity control, improve moisture permeability (cure through depth) and adhesion promotion.

The synthesis mechanism is described as follows:

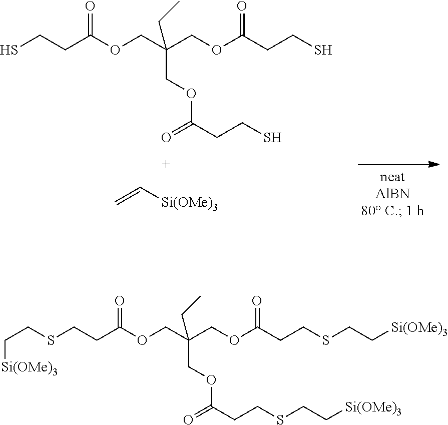

Preparation of the adduct was as follows. 64.4 g (0.16 moles) of TMMP was placed in a 250 ml three-necked round bottom flask equipped with a magnetic stirrer, nitrogen inlet, thermocouple, and heating mantel. The vinyltrimethoxysilane equivalent, 71.60 g (0.48 moles), was added and the mixture stirred to give a homogeneous solution. 0.130 g (0.8 mmoles) of 2,2′-Azobis(2-methylpropionitrile) (“AIBN”) was added and dissolved. The headspace was swept with nitrogen and the solution heated up to 80° C., during which time bubbles of nitrogen were formed from the decomposition of the azonitrile initiator. Aliquots of the mixture were removed and analyzed for unreacted vinyl by infrared spectroscopy. After one hour the vinyl group was completely consumed. The reaction was cooled and the required product, tris-(trmethoxysilane)-functional ester, was obtained as a light yellow liquid (130.54 g; 96% yield).

The structure was confirmed by spectroscopic and titrimetric analyses:

IR (ATR film) [cm⁻¹]: 2943 (—CH₂); 2841 (—CH₃); 1736 (C═O), 1464 (CH₂), 878 (Si—O).

¹H-NMR (300 MHz; CDCl₃) [ppm]: 4.05-4.04 (m, 6H, CH₂—O—C═O); 3.60-3.57 (m, 27H, O—CH3); 2.80-2.76 (m, 6H, CH2-C═O); 2.66-2.59 (m, 6H, CH2-S); 1.58 (H₂O); 1.01-0.96 (m, 3H; CH3-CH2); 0.91-0.86 (m, 6H, CH2-Si).

Thiol content (potentiometric titration, Na₂S₂O₃/I₂): 0.0769 meq/g (=2% of initial thiol content).

Examples of Moisture Curable Sealants Prepared from the Above Polysulfides

### Example 17

### Moisture Curable Formulations Formed from the Polydisulfide of Example 1

Moisture curable sealant formulations were prepared by blending together the alkoxysilane-functional polydisulfide of Example 1 (“PDS-1”) and curing catalysts as outlined in Table 3 below. The blending was carried out in a planetary speed mixer at 3000 rpm until a homogenous paste was obtained (typically five minutes). The skin-over time was determined to compare the effectiveness of the individual curing catalysts. The testing was completed at five minute intervals. The catalysts tested were dibutyltin dilaurate (“DBTDL”); bis(neodecanoyloxy) dioctylstannane (“BNDOS”); aminopropyltrimethoxysilane (“APTMS”); 1,8-diazabicyclo [5.4.0]undec-7-en (“DBU”); and N-(cyclohexylaminomethyl)-diethoxymethylsilane (“Geniosil XL-924”; Wacker Chemie). Formulations containing ≧0.5% DBTDL were slightly cloudy due to partial solubility in PDS-1 resin.

TABLE 3
Formulations and skin-over times for PDS-1 measured at 23° C. and
35% relative humidity (RH)

| Formulation | | Amount | Skin-over time |
|---|---|---|---|
| # | Catalyst | (weight %) | (minutes) |
| 1 | DBTDL | 0.2 | 85 |
| 2 | DBTDL | 0.5 | 60 |
| 3 | DBTDL | 1.0 | 55 |
| 4 | BNDOS | 0.5 | (>3 days) |
| 5 | DBTBL | 0.5 | 50 |
| | APTMS | 0.3 | |
| 6 | DBTBL | 0.5 | 35 |
| | DBU | 0.3 | |
| 7 | DBTDL | 0.5 | 45 |
| | Geniosil XL-924 | 0.3 | |
| PDS-1 | None | 0 | (>3 days) |

The data of Table 2 shows that the polydisulfide “PDS-1” resin is readily cured by addition of small amounts of common moisture curing catalysts. Combinations of tin compounds and amino silanes are particularly effective. The curing time decreases with increasing levels of tin and with increasing basicity of amine (DBU>XL-924>APTMS). Therefore a combination of DBTDL with DBU or Geniosil XL 924 can ensure a good catalysis of the moisture cure process. Clouding of the mixtures is believed to be due to partial solubility of the catalyst(s) in the polydisulfides, which have a high solubility coefficient.

A mechanical property evaluation of this relatively low molecular resin product was not possible, since it showed very weak properties due to the high crosslink density of the tri-functional moisture cured silane-group. As outlined below, higher molecular weight functionalized polydisulfides give improved tensile strength and overall better mechanical properties. It is envisioned that the relatively low molecular weight materials, LP2 and TMMP adducts, may be useful as reactive diluents for higher molecular weight alkoxysilane-functional polydisulfides for controlling viscosity and reactivity.

### Example 18

### Moisture Curable Formulations Formed from the Polydisulfides of Examples 7 and 8

Moisture curable sealant formulations were prepared by blending alkoxysilane-functional polydisulfide resins of Example 7 (“PDS-7”) and Example 8 (“PDS-8”), with catalysts, plasticizers, fillers, reactive diluents, and adhesion promoters according to Table 3 below. The ingredients were mixed in a planetary speed mixer for five minutes at 3000 rpm after which time a homogenous paste was obtained. An adduct of the reaction product of trimethylolpropane tris-3-mercaptopropionate (TMMP) and vinyltrimethoxysilane (“VTMS/TMMP”) was used to moderate the viscosity of PDS-7 resin.

TABLE 4
Moisture curing formulations of PDS-7 and PDS-8 resins

| | Formulation 8 | Formulation 9 |
|---|---|---|
| Materials | [parts by weight] | [parts by weight] |
| PDS-7 | 69.5 | |
| PDS-8 | | 67 |
| VTMS/TMMP Adduct | 5 | |
| Calcium carbonate¹ | 17 | 28 |
| Fumed silica² | 4 | |
| DBTDL | 0.2 | 0.5 |
| DBU | 0.3 | 0.3 |
| Glycol ester | 4 | 4 |
| plasticizer³ | | |

¹Omyacarb UF (Omya);
²HDK-2000 (Wacker Chemie);
³Tegmar 809

Cure through depth measurements were made by preparing thick films (5-6 mm) of the formulations on polyester foil and allowing the films to cure under ambient conditions at 23° C. and 35% RH. Samples “cubes” were cut at twenty-four intervals and the uncured liquid portion remaining on the underneath side was carefully removed by wiping with tissue and the thickness of the residual solid cured portion measured using a micrometer gauge. The cure through depth is then determined as the average daily curing rate until full cure was attained.

Samples for bulk property measurements (tensile strength and elongation) were prepared by applying 50-60 g of Formulation to a Teflon-coated, stainless steel, mold with the following dimensions: 6 inches×6 inches×0.075 inches. The material was covered with a Teflon sprayed paper and a heavy metal plate. The specimen was compression-molded with a load of 25 tonnes for five minutes. The metal plate was released and the specimen stored at laboratory conditions (23° C., 30% relative humidity) for twenty-four hours. Then the sample was de-molded and stored at 25° C. and 60% relative humidity for additional six days. Tensile strength and elongation at breaking points were measured using a universal testing instrument (Instron Series Automated Materials Tester) at a strain rate of 20 inch/min. according to the standard ASTM D412 as low strength, dog-bone specimens (length of the narrow portion: 6 inches, width of the narrow portion: 0.26 inches) with a thickness of 0.075 inches. The average of five specimens per formulation sample was recorded.

Shore A hardness tests were performed on an indentation durometer, with hardened steel foot 1.1 mm-1.4 mm diameter with a truncated 35° cone and an applied mass of 0.822 kg. The results of the various bulk property tests are presented in Table 5, below, and indicate that Formulations 8 and 9 have sufficient mechanical properties to function as soft sealant products and show moderately good bulk and surface curing rates.

TABLE 5
Materials properties of moisture cure polydisulfide Formulations 8 and 9.

| | Tensile | Elongation | | | |
|---|---|---|---|---|---|
| Formulation | Strength | at break | Shore A | cure rate | skin over |
| No. | [MPa] | [%] | Hardness | [mm/d] | time [min] |
| 8 | 0.40 | 8.89 | 48 | 2.3 | 40 |
| 9 | 0.93 | 48.30 | 43 | 1.9 | 45 |

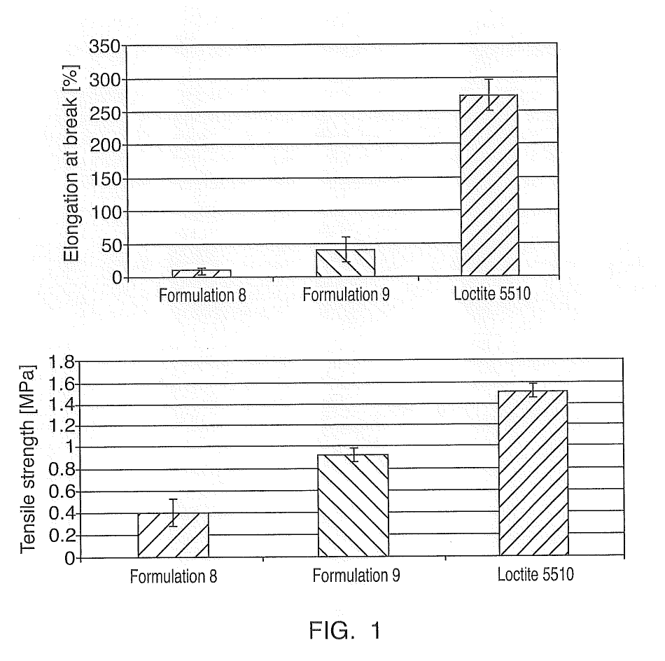

The tensile strength and the elongation at break were compared to a commercially available moisture curable, silicone-free sealant, LOCTITE FLEXTEC 5510, provided by Henkel. The results are shown in FIG. 1. Since the mechanical properties evaluation shows that the formulation with the higher molecular weight polymer (Formulation 9) has improved tensile strength and elongation at break, it is believed that higher molecular weight functionalized polymers can improve the desired properties.

Formulation 8 shows almost acceptable tensile strength, although the elongation at break is poorly developed. The result is moderately satisfactory as conventional polysulfides are known to be weak and subject to creep.

In order to improve the elongation, another set of Formulations was prepared with increasing amounts of a low molecular di-functional alkoxysilane, to study the effect of a di-functional alkoxysilane on the mechanical properties. In this case, the low molecular silane, N-cyclohexylamino-methyldiethoxymethylsilane (“Geniosil XL 924”), functions as a moisture scavenger/reagent to lower the crosslink density and as a co-catalyst for the moisture cure process. Combinations of tin compounds and amino silanes are particularly effective curing agent combinations for promoting moisture cure of alkoyxsilane polydisulfides. Since this chemical, in combination with DBTDL, showed a reasonable good skin over time for the cure of lower molecular weight products (See above) it was used to prepare test formulations having different concentrations. Additionally, the fillers were replaced by Omya BLP3, a ground calcium carbonate and Socal U1S2, a precipitated calcium carbonate to reinforce the product.

TABLE 6
Formulations of PDS-8 and varying amounts of Geniosil XL 924.

| | Formulation 10 | Formulation 11 | Formulation 12 |
|---|---|---|---|
| Materials | [parts by weight] | [parts by weight] | [parts by weight] |
| PDS-8 | 69 | 65 | 65 |
| Omya BLP3 | 7 | 7 | 7 |
| Sacal U1S2 | 19 | 19 | 19 |
| DBTDL | 0.3 | 0.2 | 0.2 |
| Geniosil XL | | 4.3 | 8.6 |
| 924 | | | |
| DBU | 0.5 | 0.3 | 0.3 |
| Glycol ester | 4.2 | 4.2 | 4.2 |
| plasticizer¹ | | | |

¹Tegmar 809

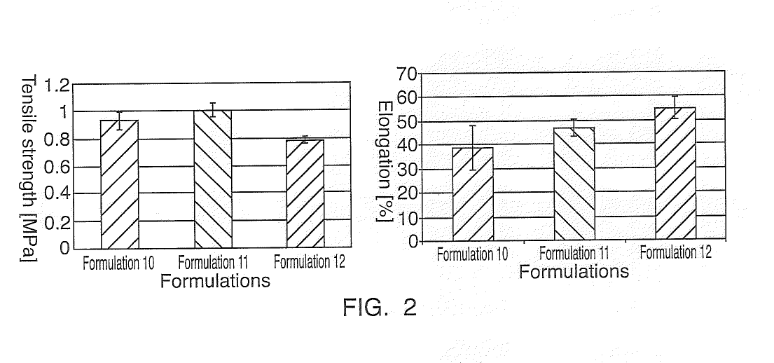

The effects of the low molecular weight di-functional alkoxysilane on tensile strength and elongation at break of the formulations are shown in FIG. 2. Increasing the amount of di-alkoxysilane results in a small but significant increase in elongation at break. This can likely be attributed to the lower crosslink-density, since lower functionality of the di-alkoxysilanes provides a wider meshed network. The tensile strengths of all three prototype formulations are similar.

### Dynamic Mechanical Analysis (DMA) of Moisture Cured Formulation 9

Dynamic mechanical analysis was carried out on a Rheometrics RDA II (National Instruments) using torsion rectangular geometry over temperature range from −60° C. to +60° C. at frequency of 1.59 Hz (10 rad/sec) and heating rate of 2° C./min. Sample specimens were prepared and cured as described for the tensile strength tests, above, with approximate dimensions of 120 mm×30 mm×2 mm The data, presented in Table 7, below, indicate a glass transition temperature (“Tg”) at approximately −45° C. (tan 6 max) and with good stiffness (G′) both below and above the phase transition. The results indicate that this formulation has sufficient mechanical integrity and elastomeric properties for sealing applications at temperatures as low as −45° C.,

TABLE 7
DMA results for moisture cured Formulation 9 (PDS-8)

| | |
|---|---|
| Tan δ max | −45° C. |
| G′ at −60° C. | 2 GPa |
| G′ at 0° C. | 4 MPa |

### Chemical Resistance of Formulations 8 and 9

The resistances of moisture cured polydisulfide sealant Formulations 8 and 9 to motor oil, n-heptane, anti-freeze, and hot water were determined by measuring the fractional weight gain (degree of swelling) or weight loss (extraction) after immersion for several weeks. Sample specimens of Formulations 8 and 9, prepared and cured according to the procedures described for the tensile strength specimens, above, were cut to the approximate dimensions 10×10×2 mm³ and accurately weighed (w₀). Periodically, samples of the specimens were removed, the surface fluid removed by absorption onto filter paper, and immediately reweighed (w₁). The degree of swelling and extraction were calculated by Equations (1) and (2), respectively:

$$\begin{matrix}Degree of swelling ( \% ) = \frac{( {w}_{1} - {w}_{0} ) \times 100}{{w}_{0}} & Equation 1 \\ Degree of extraction ( \% ) = \frac{- ( {w}_{1} - {w}_{0} ) \times 100}{{w}_{0}} & Equation 2\end{matrix}$$

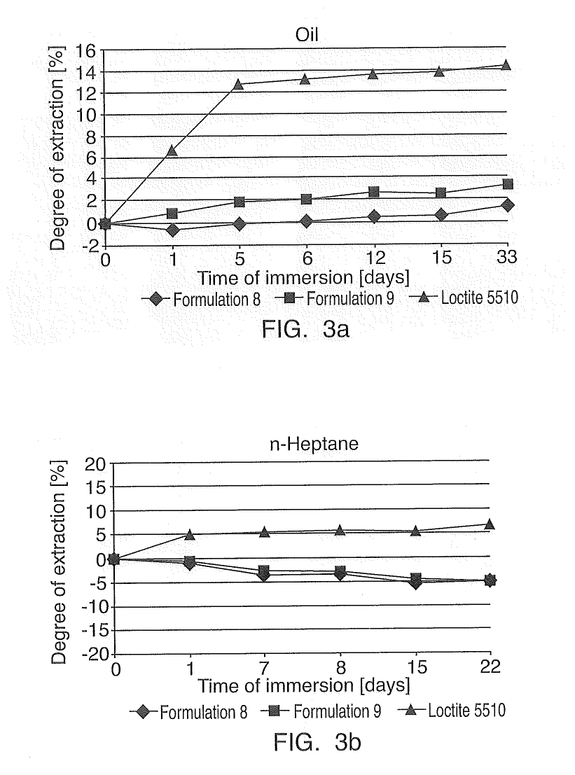

The results are presented in FIGS. 3a-d and are compared to the resistance of a commercially available, non-polydisulfide-containing product, LOCTITE FLEXTEC 5510, available from Henkel North America. The results, shown in FIG. 3(a), confirm that the polydisulfide formulations have significantly better oil resistance compared to the commercially available, non-polydisulfide product when immersed in Mobil #1 motor oil. After one day there is already a significant loss of material from the non-polydisulfide product, while the polydisulfide formulations are essentially unchanged.

When immersed in n-heptane, the polydisulfide and non-polydisulfide materials behave differently, as shown in FIG. 3(b). The polydisulfide formulation slowly loses weight over the first fifteen days after which no further loss is observed. This weight loss can most likely be attributed to diffusion of a heptane soluble component from the cured adhesive and the amount of weight loss, i.e., ˜4%, corresponds to the amount of added plasticizer in the formulation (See above) and indicates that the polydisulfide material has excellent resistance to heptane (and related hydrocarbon fuel components). In contrast, the non-polydisulfide product swells rapidly during the first day and more slowly thereafter, indicating lower resistance to the hydrocarbon solvent.

From FIG. 3(c), Formulation 8 showed better resistance than both non-polydisulfide product and Formulation 9 when immersed in anti-freeze. Formulation 8, derived from relatively low molecular weight LP-2 which has a relatively high degree of branching, is expected to give a cured polymer with a higher crosslinked density than that of Formulation 9. The relatively high degree of swelling observed for Formulation 9 is most likely attributed to a relatively low crosslink density.

From FIG. 3(d), although the degree of swelling in hot water (75° C.) appears to be comparable for the polydisulfide and non-polydisulfide products, a visual examination of the films after 22 days immersion indicated significant degradation of the non-polydisulfide product had occurred, while the polydisulfide materials, although swollen, remained intact and showed no signs of degradation.

### Example 19

### Moisture Curable Formulations Containing a Blend of the Polydisulfides of Examples 9 and 14

A moisture-curable formulation, Formulation 10, was prepared from the polydisulfide resins of Examples 9 (“PDS-9”) and 14 (“PDS-14”) according to Table 8, below.

TABLE 8
Moisture curing formulation of PDS-9 and PDS-14 blend

| | Formulation 13 |
|---|---|
| Components | (parts) |
| PDS-9 | 33 |
| PDS-14 | 10 |
| Dimethoxymethylvinylsilane | 6 |
| Geniosil XL926¹ | 3 |
| DBTDL | 0.6 |
| Plasticizer² | 1.4 |
| Calcium carbonate | 46 |

¹N-(cyclohexylaminomethyl)triethoxysilane (Wacker Chemie).
²Alkylsulfonate ester (Mesamoll; Lanxess)

The material and dynamic mechanical properties of a moisture-cured sample of Formulation 13 were measured by the procedures described above, and the results are presented in Table 9 below.

TABLE 9
Physical and mechanical properties of moisture cured Formulation 13

| Physical/mechanical Test | Result |
|---|---|
| Tensile strength | 1.3 MPa |
| Elongation at break | 144% |
| Shore A hardness | 55 |
| Skin-over time | 25 min. |
| Cure through depth rate | 1.3 mm/d |
| Glass transition temperature, Tg | −44° C. |
| G′ at −60° C. | 3.0 GPa |
| G′ at 0° C. | 2.6 MPa |

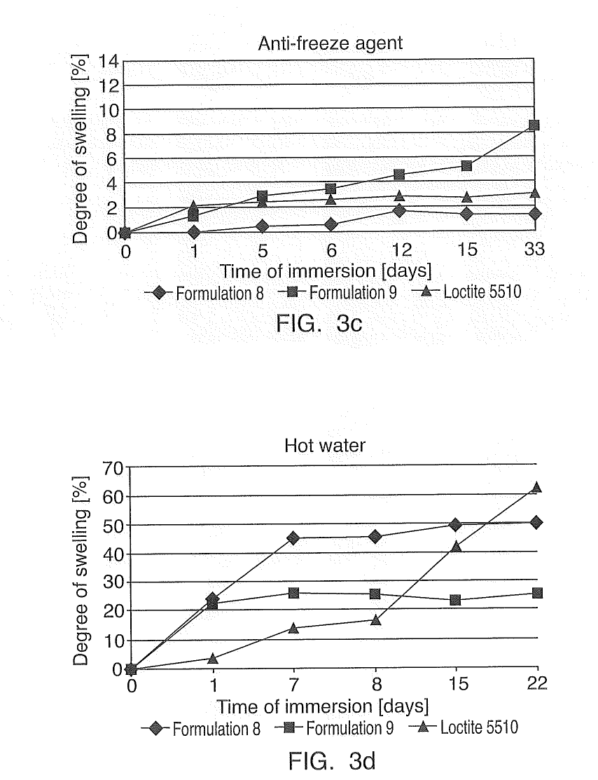

The results demonstrate that formulations containing blends of moisture-cured polydisulfides having different molecular weights, polymer backbones, and end-functional groups provide sealants with excellent physical and mechanical properties. In addition, these formulations exhibit superior chemical resistance to oils and oil-based products compared to commercially available non-polydisulfide products as demonstrated by degree of extraction in motor oil, shown in FIG. 4.

### Example 20

### Moisture Curable Formulations Containing a Blend of the Polydisulfides of Examples 13-16

Moisture curable Formulations 14-16 were prepared by blending the polydisulfide resins described in Examples 13-16, above, (“PDS-13”, “PDS-14”, “PDS-15”, and “PDS-16”, respectively) together with various additives as outlined in Table 10, below, according to the process described in Example 17.

TABLE 10
Moisture curing formulations containing PDS resins 13, 14, 15 and 16

| | Formulation 14 | Formulation 15 | Formulation 16 |
|---|---|---|---|
| | (parts by | (parts by | (parts by |
| Component | weight) | weight) | weight) |
| PDS-13 | 34.0 | | |
| PDS-14 | 10.0 | 10 | 10 |
| PDS-15 | | 34 | |
| PDS-16 | | | 34 |
| dimethoxyvinylsilane | 5.0 | 5.0 | 5.0 |
| Geniosil XL926¹ | 2.4 | 2.4 | 2.4 |
| DBTDL | 0.5 | 0.5 | 0.5 |
| Plasticizer² | 1.3 | 1.3 | 1.3 |
| Calcium carbonate³ | 46.8 | 46.8 | 46.8 |

¹N-(cyclohexylaminomethyl)triethoxysilane (Wacker Chemie)
²Alkylsulfonate ester (Mesamoll; Lanxess)
³combination of 11.8 wt % Omya BLP 3 and 35 wt % Socal U1S2

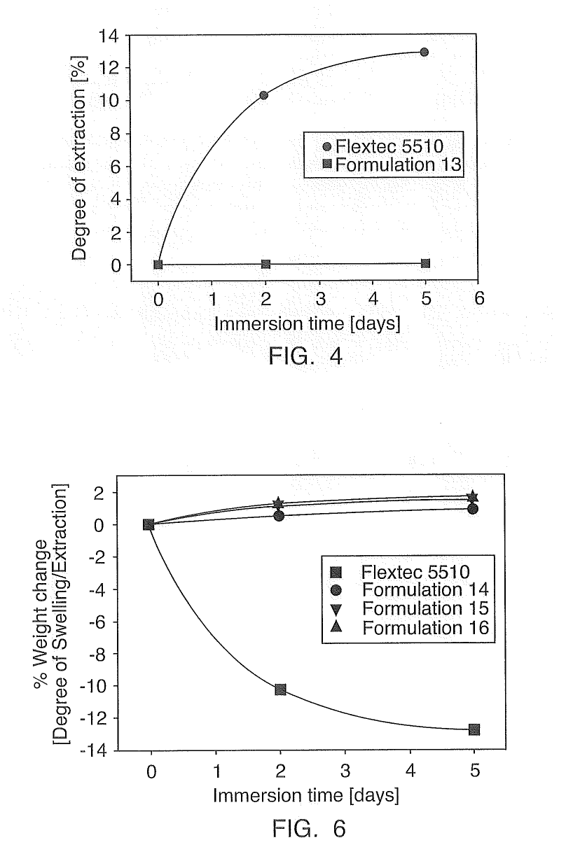

Films of each of the formulations listed in Table 10 were prepared, cured by controlled exposure to atmospheric moisture, and tested according to the procedures described above. The tests were carried out both before and after immersion in motor oil for one week. The results, presented in FIG. 5 show that there is little or no significant change in the tensile strength or flexibility of the materials as a result of immersion in the oil medium.

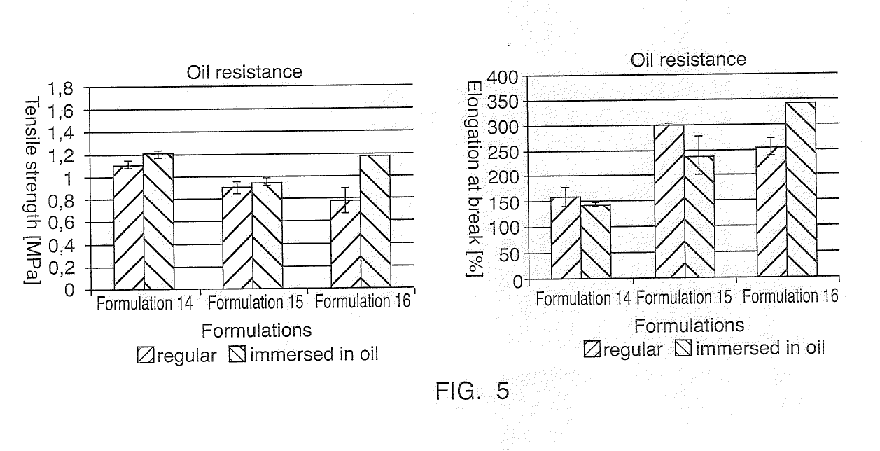

Weight changes in the samples of Formulations 14-16 were measured as a function of immersion time and the degree of swelling, or extraction, was calculated as described above. The data, presented in FIG. 6, clearly show that Formulations 14-16, which contain polydisulfide resin(s), have significantly better resistance to oil than a non-polydisulfide-containing sealant.

Dynamic mechanical analysis (“DMA”) was also conducted on cured specimens of Formulations 14-16 according to the procedure described above. The results, presented in Table 11, show that Formulations 14-16 have glass transition temperatures (“Tg”) in the region −40° C. -50° C. and excellent mechanical properties (elastic moduli, G′ values) up to 80° C. These products are particularly well suited for sealing against aggressive oils and chemicals from very low to moderately high temperatures.

TABLE 11
DMA results for formulation 14-16

| DMA Result | Formulation 14 | Formulation 15 | Formulation 16 |
|---|---|---|---|
| Tg (° C.) | −46 | −46 | −43 |
| (Tan δ max) | | | |
| G′ at −60° C. (GPa) | 2.3 | 2.2 | 2.1 |
| G′ at 0° C. (MPa) | 20 | 8.5 | 12 |

What is claimed is:

1. A reaction product prepared from reactants comprising:
a) at least one thiol-functional polydisulfide; and
b) at least one alkoxy silane, wherein the alkoxy silane has at least one alkenyl functional group,
wherein the reaction product is prepared in the presence of a free radical initiator.

2. The reaction product of claim 1, wherein the alkoxy silane is represented by the formula: 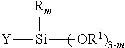
wherein m is 0-2; R is C₁₋₆ alkyl or C₆ aryl, which may optionally be substituted by halo, sulfur or oxygen; each R¹ is independently alkyl; and Y is an alkenyl group.

3. The reaction product of claim 2, wherein the alkoxy silane is selected from the group consisting of: vinyltrimethoxysilane, allyltrimethoxysilane, and combinations thereof.

4. A reaction product prepared from reactants comprising:
a) at least one thiol-functional polydisulfide; and
b) at least one alkoxy silane, wherein the alkoxy silane has at least one isocyanato-functional group.

5. The reaction product of claim 4, wherein the at least one thiol-functional polydisulfide is prepared from reactants comprising at least one material having at least two acryl-functional groups and a thiol-functional polydisulfide material.

6. The reaction product of claim 4, wherein the at least one thiol-functional polydisulfide is a prepared from reactants comprising at least one material having at least two isocyanato-functional groups and at least one thiol-functional polydisulfide material.

7. A reaction product prepared from reactants comprising:
(a) at least one isocyanato-functional polydisulfide; and
(b) at least one alkoxy silane having at least one amino-functional group.

8. The reaction product of claim 7, wherein the at least one isocyanato-functional polydisulfide is prepared from reactants comprising at least one isocyanato-functional material and at least one thiol-functional polydisulfide material.

9. A reaction product prepared from reactants comprising:
(a) at least one acryl-functional polydisulfide; and
(b) at least one alkoxy silane having at least one thiol-functional group.

10. The reaction product of claim 9, wherein the at least one acryl-functional polydisulfide is prepared from reactants comprising at least one material having at least two acryl-functional groups and at least one thiol-functional polydisulfide material.

11. A moisture curable sealant comprising the reaction product of claim 1 and at least one catalyst.

12. A moisture curable sealant comprising the reaction product of claim 2 and at least one catalyst.

13. A moisture curable sealant comprising the composition of claim 7 and at least one cure catalyst.

14. A moisture curable sealant comprising the reaction product of claim 9 and at least one catalyst.

15. A process of preparing a polydisulfide comprising the step of:
reacting reactants comprising at least one thiol-functional polydisulfide and at least one alkoxy silane having at least one alkenyl-functional group in the presence of a free radical initiator to form a polydisulfide having at least one alkoxy silane end group.

16. A process of preparing a polydisulfide comprising the step of:
reacting reactants comprising at least one thiol-functional polydisulfide and at least one alkoxy silane having at least one isocyanato-functional group to form a polydisulfide having at least one alkoxy silane end group.

17. The process of claim 16, wherein the polydisulfide is prepared by reacting the reactants free of or essentially free of a catalyst.

18. A process of preparing a polydisulfide comprising the step of:
reacting reactants comprising at least one isocyanato-functional polydisulfide and at least one alkoxy silane having at least one amino-functional group to form a polydisulfide having at least one alkoxy silane end group.

19. A process of preparing a polydisulfide comprising the step of:
reacting reactants comprising at least one acryl-functional polydisulfide and at least one alkoxy silane having at least one thiol-functional group to form a polydisulfide having at least one alkoxy silane end group.

20. The process of claim 19, wherein the acryl-functional polydisulfide is prepared by reacting at least one material having at least two acryl-functional groups and at least one thiol-functional polydisulfide material.
